(19) United States
(12) Patent Application Publication
(10) Pub. No.: US 2009/0015917 A1
(43) Pub. Date: Jan. 15, 2009

(54) THREE-DIMENSIONAL IMAGE DISPLAY APPARATUS

(75) Inventors: Kyohei Iwamoto, Tokyo (JP); Tetsuyuki Miyawaki, Kanagawa (JP); Yoshio Suzuki, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/137,167

(22) Filed: Jun. 11, 2008

(30) Foreign Application Priority Data
Jun. 27, 2007 (JP) 2007-169409
Apr. 30, 2008 (JP) 2008-118533

(51) Int. Cl. G02B 27/26

(52) U.S. Cl. 359/462

(57) ABSTRACT

In the present invention, there is provided a three-dimensional image display apparatus, including: (A) a light source including U₀×V₀ planar light emitting members disposed in a two-dimensional matrix; (B) an optical modulation section having a plurality of pixels modulating light beams successively outputted from the planar light emitting members by section of each of the pixels to produce a two-dimensional image and emitting spatial frequencies of the produced two-dimensional image along a plurality of diffraction angles corresponding to different diffraction orders produced from the pixels; and (C) a Fourier transform image forming section Fourier transforming the spatial frequencies of the two-dimensional image emitted from the optical modulation section to produce a number of Fourier transform images corresponding to the number of diffraction orders and forming the Fourier transform images.

### CROSS REFERENCES TO RELATED APPLICATIONS

The present invention contains subject matter related to Japanese Patent Application JP 2007-169409 filed in the Japan Patent Office on Jun. 27, 2007, and to Japanese Patent Application JP 2008-118533 filed in the Japan Patent Office on Apr. 30, 2008, the entire contents of which being incorporated herein by reference.

### BACKGROUND OF THE INVENTION

1. Field of the Invention

This invention relates to a three-dimensional image display apparatus which can display a stereoscopic image.

2. Description of the Related Art

A two-eye type stereoscopic image technique of obtaining a stereoscopic image by observing different images called parallax images by respective eyes of an observer and a multi-eye type stereoscopic image technique of obtaining a plurality of stereoscopic images from different visual points by preparing a plurality of sets of parallax images are known, and various related techniques have been developed. However, in the two-eye type stereoscopic image technique and the multi-eye type stereoscopic image technique, a stereoscopic image is not positioned in a space intended therefor but exists, for example, on a two-dimensional display plane and is always positioned at a fixed position. Accordingly, the convergence and the adjustment which are physiological reactions of the visual system do not interlock with each other, and this gives rise to a problem of the eyestrain.

On the other hand, in the real world, information of the surface of a physical solid propagates as light waves through a medium to the eyeballs of an observer. As a technique of artificially reproducing light waves from the surface of a physical solid which physically exists in the real world, a holography technique is known. A stereoscopic image produced using a holography technique is formed using interference fringes produced based on interference of light and using a diffracted wave front itself, which appears when the interference fringes are illuminated with light, as an image information medium. Accordingly, visual system physiological reactions such as convergence and adjustment similar to those when an observer observes a physical solid in the real world occur, and an image which provides a comparatively small amount of eyestrain can be obtained. Further, that a light wavefront from a physical solid is reproduced signifies that the continuity is assured in a direction in which image information is transmitted. Accordingly, even if the visual point of the observer moves, an appropriate image from a different angle according to the movement can be presented continuously, and parallax images are successively provided.

However, in the holography technique, three-dimensional space information of a physical solid is recorded as interference fringes in a two-dimensional space, and the information amount of the three-dimensional image is very great when compared with that of a two-dimensional image of a photograph or the like obtained by image pickup of the same physical solid. This is because it can be considered that, when the three-dimensional space information is converted into two-dimensional space information, the information is converted into the density on the two-dimensional space. Therefore, the spatial resolution required for a display apparatus which displays interference fringes from a CGH (Computer Generated Hologram) is very high, and a very great information amount is required. Thus, in the present situation, it is technically difficult to implement a stereoscopic image based on a real-time hologram.

In the holography technique, a light wave which can be regarded as continuous information is used as an information medium to transmit information from a physical solid. Meanwhile, as a technique of discretizing a light wave and reproducing a situation, which is theoretically almost equivalent to a field formed from a light wave in the real world, from light beams to produce a stereoscopic image, a light beam reproduction method also called integral photography method is known. In the light beam reproduction method, a light beam group composed of a large number of beams of light propagating in many directions is scattered into the space by optical means in advance. Then, beams of light propagated from the surface of a virtual physical solid positioned at an arbitrary position are selected from within the light beam group, and the selected light beams are modulated in intensity or phase to produce images composed of the beams of light in the space. An observer can observe the images as a stereoscopic image. A stereoscopic image according to the light beam reproduction method includes a plurality of images from different directions formed multiply at an arbitrary point, and an arbitrary point of the stereoscopic image looks in a different manner depending upon the position from which it is viewed similarly as in the case where a three-dimensional physical solid in the real world is observed.

As an apparatus for implementing the light beam reproduction method described above, apparatus which include a combination of a flat display apparatus such as a liquid crystal display apparatus or a plasma display apparatus and a microlens array or a pinhole array have been proposed. Such apparatus are disclosed in Japanese Patent Laid-Open No. 2003-173128, Japanese Patent Laid-Open No. 2003-161912, Japanese Patent Laid-Open No. 2003-295114, Japanese Patent Laid-Open No. 2003-75771, Japanese Patent Laid-Open No. 2002-72135, Japanese Patent Laid-Open No. 2001-56450, and Japanese Patent No. 3,523,605. Also an apparatus which includes a large number of projector units juxtaposed with each other may be applicable. FIG. 32 shows an example of a configuration of a three-dimensional image display apparatus which uses a projector unit to implement a light beam reproduction method. Referring to FIG. 32, the three-dimensional image display apparatus is configured such that a large number of projector units 501 are disposed in parallel in a horizontal direction and a vertical direction such that beams of light having different angles are emitted from the respective projector units 501. Consequently, images of multiple visual angles are reproduced multiply at an arbitrary point in a certain sectional plane 502.

Further, Japanese Patent Laid-Open No. 2007-041504 mentioned hereinabove discloses a three-dimensional image display apparatus which includes:

(A) optical modulation means having a plurality of pixels for modulating light from a light source by means of each of the pixels to produce a two-dimensional image and emitting spatial frequencies of the produced two-dimensional image along diffraction angles corresponding to a plurality of diffraction orders produced from the pixels;

(B) Fourier transform image forming means for Fourier transforming the spatial frequencies of the two-dimensional image emitted from the optical modulation means to produce a number of Fourier transform images corresponding to the number of the plural diffraction orders;

(C) Fourier transform image selection means for selecting, from among the number of produced Fourier transform images corresponding to the plural diffraction orders, that Fourier transform image which corresponds to a desired diffraction order; and

(D) conjugate image forming means for forming a conjugate image of the Fourier transform image selected by the Fourier transform image selection means.

### SUMMARY OF THE INVENTION

With the light beam reproduction method, an image is produced from such a degree of a beam of light as to effectively act on focus adjustment and binocular convergence angle adjustment as visual sense functions, which have been impossible with the two-eye type stereoscopic image technique or the multi-eye type stereoscopic image technique. Therefore, a stereoscopic image which provides a very small amount of eyestrain can be provided. Besides, since beams of light are continuously emitted in a plurality of directions from the same element on a virtual physical solid, variation of the image by movement of the visual point position can be provided continuously.

However, an image produced by the light beam reproduction method in the existing condition lacks in the realism when compared with a physical solid in the real world. It is considered that this arises from the fact that a stereoscopic image by the light beam reproduction method in the existing condition is produced from a very small amount of information, that is, a very small amount of beams of light when compared with the amount of information which the observer acquires from a physical solid in the real world. It is considered that generally the visibility limit of the human being is approximately one minute in angular resolution, and a stereoscopic image by the light beam reproduction method in the existing condition is produced from beams of light insufficient with respect to the visual sense. Accordingly, in order to produce a stereoscopic image having a high degree of reality which a physical solid in the real world has, it is a subject at least to produce an image from a large number of beams of light.

In order to implement this, a technique by which a group of beams of light can be produced in a spatially high density is required, and it seems a possible idea to raise the display density of a display apparatus such as a liquid crystal display apparatus. Or, in the case of the apparatus shown in FIG. 32 wherein a large number of projector units 501 are disposed, it is a possible idea to miniaturize the projector units 501 such that they are juxtaposed in a spatially high density. However, rapid improvement of the display density in display apparatus at present is difficult from the problem of the light utilization efficiency or the diffraction limit. Further, in the case of the apparatus shown in FIG. 32, there is a limitation to the miniaturization of the projector units 501, and it is considered difficult to juxtapose the projector units 501 in a spatially high density. In any case, in order to produce a group of beams of light in a high density, a plurality of devices are required and increase in size of the entire apparatus cannot be avoided.

In the three-dimensional image display apparatus disclosed in Japanese Patent Laid-Open No. 2007-041504, a group of beams of light necessary for display of a stereoscopic image can be produced and scattered in a spatially high density without increasing the size of the entire three-dimensional image display apparatus, and a stereoscopic image based on beams of light proximate in quality to a physical solid in the real world can be obtained. However, with the three-dimensional image display apparatus disclosed in Japanese Patent Laid-Open No. 2007-041504, Fourier transform images selected by the Fourier transform image selection means look as bright points which waft, in the space, in a state wherein they are arrayed in a two-dimensional matrix. Consequently, the line of sight of an observer is likely to be led to the bright points naturally, which makes it difficult for the observer to observe the stereoscopic image.

Further, for example, where the light source is formed from light emitting devices, if a dispersion in luminance occurs with the light emitting devices, then luminance unevenness appears with the produced image. According to circumstances, a variation occurs with a color tone of the image, which makes a cause of deterioration of the quality of the image. The dispersion in luminance of the light emitting devices not only occurs upon mounting of the light source on the three-dimensional image display apparatus, that is, upon assembly of the three-dimensional image display apparatus, but also is caused by the secular change or variation of the operation environment.

Therefore, it is demanded to provide a three-dimensional image display apparatus by which a light beam group necessary for display of a stereoscopic image can be produced and scattered in a spatially high density without increasing the size of the entire apparatus. Further, it is demanded to provide a three-dimensional image display apparatus by which a stereoscopic image based on beams of light of quality proximate to that of a physical solid in the real world can be obtained. Furthermore, it is demanded to provide a three-dimensional image display apparatus which can produce a stereoscopic image to which the line of sight of an observer can be led naturally. Also it is demanded to provide a three-dimensional image display apparatus by which, even if some change occurs with the intensity of light emitted from a light source, deterioration of the quality of an image to be displayed is not invited.

According to a first embodiment of the present invention, there is provided a three-dimensional image display apparatus, including:

(A) a light source including U₀×V₀ planar light emitting members disposed in a two-dimensional matrix;

(B) optical modulation means having a plurality of pixels for modulating each of light beams successively outputted from the planar light emitting members by means of each of the pixels to produce a two-dimensional image and emitting spatial frequencies of the produced two-dimensional image along a plurality of diffraction angles corresponding to different diffraction orders produced from the pixels; and

(C) Fourier transform image forming means for Fourier transforming the spatial frequencies of the two-dimensional image emitted from the optical modulation means to produce a number of Fourier transform images corresponding to the number of diffraction orders and forming the Fourier transform images.

Preferably, the three-dimensional image display apparatus according to the first embodiment of the present invention further includes

(D) conjugate image forming means for forming conjugate images of the Fourier transform images formed by the Fourier transform image forming means.

According to a second embodiment of the present invention, there is provided a three-dimensional image display apparatus, including:

(A) a light source including U₀×V₀ planar light emitting members disposed in a two-dimensional matrix;

(B) a two-dimensional image forming apparatus having a plurality of apertures arrayed in a two-dimensional matrix in X and Y directions and configured to control passage or reflection of each of light beams successively emitted from the planar light emitting members individually for the apertures to produce a two-dimensional image and produce a plurality of diffraction light beams of different diffraction orders individually for the apertures based on the two-dimensional image;

(C) a first lens having a front side focal plane on which the two-dimensional image forming apparatus is disposed;

(D) a second lens having a front side focal plane positioned on a rear side focal plane of the first lens; and

(E) a third lens having a front side focal plane positioned on a rear side focal plane of the second lens.

In the three-dimensional image display apparatus according to the first or second embodiment of the present invention including the preferred form thereof (such three-dimensional image display apparatus of the first and second embodiments may hereinafter referred to sometimes as “three-dimensional image display apparatus of the present invention”), the number of Fourier transform images formed from the light from the light source is the number of diffraction orders×U₀×V₀. A Fourier transform image obtained based on a light beam emitted from each planar light emitting member (such light beam may be hereinafter referred to as “illuminating light beam”) is formed not in the form of spot but with some area, particularly, for example, in the form of a rectangular shape, by the Fourier transform image forming means or the first lens corresponding to the position of the planar light emitting member. It is to be noted that, if Fourier transform image selection means or a spatial filter hereinafter described is disposed, then the number of Fourier transform images formed from the illuminating light beams finally is U₀×V₀.

Further, in the three-dimensional image display apparatus according to the first embodiment of the present invention including the preferred configuration and form described above, the Fourier transform image forming means may be configured such that it includes a lens or first lens having a front side focal plane on which the optical modulation means is disposed.

While, in the three-dimensional image display apparatus according to the first embodiment of the present invention, the images produced and formed by the Fourier transform image forming means correspond to the diffraction orders, an image obtained based on a comparatively low diffraction order is comparatively bright while an image obtained based on a comparatively high diffraction order is comparatively dark. Therefore, a stereoscopic image of sufficiently high picture quality can be obtained. However, in order to further improve the picture quality, preferably the three-dimensional display apparatus further includes

(E) Fourier transform image selection means for selecting a Fourier transform image corresponding to a desired diffraction order from among the number of produced Fourier transform images corresponding to the number of diffraction orders.

In the three-dimensional image display apparatus, the Fourier transform image selection means is disposed at a position at which the Fourier transform images are formed.

Also in the three-dimensional image display apparatus according to the second embodiment of the present invention, the images produced and formed by the first lens correspond to the diffraction orders, an image obtained based on a comparatively low diffraction order is comparatively bright while an image obtained based on a comparatively high diffraction order is comparatively dark. Therefore, a stereoscopic image of sufficiently high picture quality can be obtained. However, in order to further improve the picture quality, preferably the three-dimensional display apparatus further includes

(F) a spatial filter having U₀×V₀ openings controllable between open and closed states and positioned on the rear side focal plane of the first lens. In this instance, preferably the spatial filter places a desired aperture into an open state in synchronism with a production timing of the two-dimensional images by the two-dimensional image forming apparatus. Or, preferably the three-dimensional image display apparatus further includes

(F) a scattering diffraction limiting member having U₀×V₀ apertures and positioned on the rear side focal plane of the first lens. By disposing the spatial filter or the scattering diffraction limiting member, it is possible to pass only a desired one of the produced diffraction light beams of the different diffraction orders.

Preferably, the Fourier transform image selection means in the three-dimensional image display apparatus according to the first embodiment of the present invention or the spatial filter in the three-dimensional image display apparatus according to the second embodiment of the present invention has U₀×V₀ apertures. The apertures may be controllable between open and closed state or may always be in an open state. The Fourier transform image selection means or spatial filter which has apertures controlled between open and closed states may be a liquid crystal display apparatus, more particularly, a liquid crystal display apparatus of the transmission type or the reflection type, or a two-dimensional MEMS (Micro Electro Mechanical Systems) wherein movable mirrors are disposed in a two-dimensional matrix. Further, the Fourier transform image selection means or spatial filter which has apertures controlled between open and closed states may be configured so as to place a desired aperture into an open state in synchronism with a production timing of the two-dimensional images by the optical modulation means or two-dimensional image forming apparatus to select a Fourier transform image or a diffraction light beam corresponding to a desired diffraction order. The position of the aperture may be set to a position at which a desired one of the Fourier transform images or diffraction light beams obtained by the Fourier transform image selection means or first lens is formed, and this position of the aperture corresponds to a position at which the corresponding planar light emitting member is disposed. Further, preferably the size of the apertures of the Fourier transform image selection means is substantially same as that of the Fourier transform images formed on the Fourier transform image selection means. Meanwhile, preferably the size of the apertures of the spatial filter is substantially equal to the size of the two-dimensional images produced by the two-dimensional image forming apparatus formed on the spatial filter. It is to be noted that the size of the two-dimensional images formed on the spatial filter can be set to a suitable value by optimizing the optical system or various lenses of the three-dimensional image display apparatus. Further, the angle θ to the observer of the width of a gap existing between adjacent ones of the apertures, that is, the distance between adjacent edges of adjacent ones of the apertures, may be 2.9×10⁻⁴ radians or less.

The three-dimensional image display apparatus according to the first embodiment of the present invention including the preferred forms and configurations described above further includes inverse Fourier transform means for inverse Fourier transforming the Fourier transform images formed by the Fourier transform image forming means to form a real image of the two-dimensional images produced by the optical modulation means.

Further, in the three-dimensional image display apparatus according to the first embodiment of the present invention including the preferred forms and configurations described above, the optical modulation means may be formed from a two-dimensional spatial optical modulator having a plurality of, that is, P×Q, pixels arrayed two-dimensionally, each of the pixels having an aperture. In this instance, preferably the two-dimensional spatial optical modulator is configured from a liquid crystal display apparatus, more particularly, a liquid crystal display apparatus of the transmission type or the reflection type, or is configured such that a movable mirror is provided in each of the apertures of the two-dimensional spatial optical modulator, that is, configured from a two-dimensional MEMS wherein movable mirrors are disposed in a two-dimensional matrix. Further, in the three-dimensional image display apparatus according to the second embodiment of the present invention including the preferred forms and configurations described above, the two-dimensional image forming apparatus may be formed such that it is configured from a liquid crystal display apparatus, more particularly, a liquid crystal display apparatus of the transmission type or the reflection type, having a plurality of, that is, P×Q, pixels arrayed two-dimensionally, each of the pixels having an aperture provided therein. Or, the two-dimensional image forming apparatus may be formed such that it has a plurality of, that is, P×Q, apertures, in each of which a movable mirror is provided, that is, formed from a two-dimensional MEMS wherein a movable mirror is disposed in each of apertures array in a two-dimensional matrix. Here, preferably the apertures have a rectangular shape in plan. Where the apertures have a rectangular shape in plane, Fraunhofer diffraction is caused by the apertures, and M×N diffraction light beams are produced. In particular, such apertures form amplitude gratings which can periodically modulate the amplitude or intensity of an incoming light wave to obtain a light amount distribution coincident with the light transmission factor distribution of the gratings.

Further, the three-dimensional image display apparatus according to the first embodiment of the present invention including the preferred forms and configurations described above may be configured such that the spatial frequency of the two-dimensional images corresponds to image information whose carrier frequency is the spatial frequency of the pixel structure and further that the spatial frequency of conjugate images of the two-dimensional images hereinafter described is a spatial frequency obtained by removing the spatial frequency of the pixel structure from the spatial frequency of the two-dimensional images. In particular, a spatial frequency which is obtained by first-order diffraction with a carrier frequency of 0th-order diffraction of a plane wave component and is lower than one half the spatial frequency of the pixel structure or aperture structure of the optical modulation means is selected by the Fourier transform image selection means or spatial filter or passes through the Fourier transform image selection means or spatial filter. Spatial frequencies displayed on the optical modulation means or the two-dimensional image forming apparatus are all transmitted.

In the three-dimensional image display apparatus according to the embodiments of the present invention including the preferred forms and configurations described above, each of the planar light emitting members may include:

(a) a rod integrator (also called kaleidoscope) configured to emit light from a first end face thereof; and

(b) a light emitting diode disposed adjacent a second end face of the rod integrator (particularly a light emitting element of low coherence, more particularly, a light emitting diode. This similarly applies also to the following description). Where each of the planar light emitting members is formed from a rod integrator, illuminating light beams can be emitted uniformly in a planar state from the planar light emitting members. Further, for example, where a light emitting diode is used, speckle noise which matters where a laser is use does not appear. This similarly applies also to the following description.

Or, in the three-dimensional image display apparatus according to the embodiments of the present invention including the preferred forms and configurations described above, each of the planar light emitting members may include:

(a) a rod integrator configured to emit light from a first end face thereof;

(b) a light emitting diode disposed adjacent a second end face of the rod integrator;

(c) a reflection type polarizing member disposed adjacent the first end face of the rod integrator and passing part of light incoming thereto in response to a polarization state of the light while reflecting the remaining part of the light; and

(d) a light reflecting member provided at a portion of the second end face of the rod integrator at which the light reflecting member does not intercept light emitted from the light emitting diode. In this instance, each of the planar light emitting members may further include

(e) a quarter-wave plate disposed between the second end face of the rod integrator and the light reflecting member. Furthermore, each of the planar light emitting members may further include

(f) a light diffusing member provided on the reflection type polarizing member.

Or, in the three-dimensional image display apparatus according to the embodiments of the present invention including the preferred forms and configurations described above, each of the planar light emitting members may include:

(a) a P and S polarized light separation conversion element including a first prism, a second prism and a polarizing beam splitter; and

(b) a light emitting diode.

In the three-dimensional image display apparatus, the first and second prisms are disposed in an opposing relationship across a polarized light separation face of the polarizing beam splitter,

the first prism having first and second light reflecting members provided at portions thereof at which the first and second light reflecting members do not intercept light emitted from the light emitting diode,

an S polarized light component of light emitted from the light emitting diode and incoming to the first prism is reflected by the polarizing beam splitter, reflected by the second light reflecting member, reflected by the polarizing beam splitter again and then reflected by the first light reflecting member,

a P polarized light component of the light emitted from the light emitting diode and incoming to the first prism and a P polarized light component of the light reflected by the first light reflecting member pass through the polarizing beam splitter thereby to go out from an outgoing face of the second prism. In this instance, each of the planar light emitting members may further include

(c) a quarter-wave plate disposed between the first prism and the first light reflecting member.

The first prism may be formed, for example, from a triangular prism having a first inclined face, a second inclined face and a bottom face. Also the second prism may be formed from a triangular prism having a first inclined face, a second inclined face and a bottom face. In this instance, the bottom face of the first prism and the bottom face of the second prism are disposed in an opposing relationship to each other across a polarized light separation face of the polarizing beam splitter. The first light reflecting member is disposed on the first inclined face of the first prism, and as occasion demands, the quarter-wave plate is disposed between the first inclined face of the first prism and the first light reflecting member. The second light reflecting member is disposed on the second inclined face of the first prism. An S polarized light component of light incoming through the first inclined face of the first prism is reflected toward the second inclined face of the first prism by the polarizing beam splitter. Meanwhile, a P polarized light component passes through the polarizing beam splitter and goes out from the first inclined face of the second prism.

Or else, in the three-dimensional image display apparatus according to the embodiments of the present invention including the preferred forms and configurations described above, each of the planar light emitting members may include:

(a) a plate-formed member configured to emit light from a first end face thereof;

(b) a light emitting diode disposed adjacent a second end face of the plate-formed member;

(c) a reflection type polarizing member disposed adjacent the first end face of the plate-formed member and configured to pass part of incoming light therethrough in response to a polarization state of the light while reflecting the remaining part of the incoming light;

(d) a light reflecting member provided at a portion of the second end face of the plate-formed member at which the light reflecting member does not intercept the light emitted from the light emitting diode;

(e) a quarter-wave plate disposed between the second end face of the plate-formed member and the light reflecting member; and

(f) a light diffusing member provided on the reflection type polarizing member.

Here, the rod integrator may be a hollow member which has a rectangular shape when it is taken along a virtual plan perpendicular to the axial line thereof and is open at the opposite end faces thereof. Or, the rod integrator may be a hollow member whose first end face is open and whose second end face is formed from a light diffusing face. In this instance, preferably a light reflecting layer is provided on an inner face or an outer face of the hollow member. Or else, the rod integrator may be a solid member which has a rectangular sectional shape when it is taken along a virtual plan perpendicular to the axial line thereof and is made of a transparent material. Also in this instance, preferably a light reflecting layer is provided on the outer face of the solid member. It is to be noted that a light diffusing layer may be formed on the first end face of the solid member opposing to the light emitting element. The material used to form such a hollow member or a solid member as described above may be a plastic material such as a PMMA (Poly Methyl Methacrylate) resin, a polycarbonate resin (PC), a polyarylate resin (PAR), a polyethylene terephthalate resin (PET) or an acrylic resin or glass. Meanwhile, the light reflecting layer may be formed from a metal layer such as a silver layer, a chromium layer or an aluminum layer or an alloy layer formed by a physical vapor phase growth method (PVD method) such as sputtering or vacuum vapor deposition, a chemical vapor deposition method (CVD method) or plating. In order to obtain a light source by arraying U₀×V₀ planar light emitting members in a two-dimensional matrix, for example, they may be bound using a suitable binding member after they are arrayed or collected in a two-dimensional matrix. It is to be noted that, where the planar light emitting members are arrayed in a two-dimensional matrix, preferably no gap or space exists between the first end faces or light going faces of adjacent ones of the planar light emitting members. A light beam emitted from the light emitting diode enters the rod integrator from the light incoming end face or second end face of the rod integrator. Then, it is successively reflected in the inside of the rod integrator and then goes out from the light outgoing end face or first end face of the rod integrator. Therefore, uniformization of the light beams outgoing from the rod integrators can be achieved. Besides, light is emitted in a planar fashion from the light outgoing ends or first end faces of the rod integrators.

Depending upon the specifications of the three-dimensional image display apparatus, monochromatic light may be emitted from the planar light emitting members. In particular, light from a red light emitting diode, a green light emitting diode or a blue light emitting diode may be emitted, or white light such as light from a white light emitting diode may be emitted. Or the light source may be formed from a set of planar light emitting members including a red light emitting diode, planar light emitting members including a green light emitting diode and planar light emitting members including a blue light emitting diode. In this instance, the light emitting diodes in the planar light emitting members may be successively driven so that light beams, that is, red, green and blue light beams, are emitted from the light source.

The reflection type polarizing member has such a structure that, for example, ribs of aluminum are formed with a width of several tens nm in a pitch of hundred and several tens nm on the surface of a substrate made of a transparent material or has a lamination structure which includes a plurality of layers of different refraction factors laminated one on another. The arrangement of the reflection type polarizing member on the first end face of the rod integrator or the first end face of the plate-formed member can be achieved by adhering such a substrate as described above or by directly forming the lamination structure as a film although it depends upon the specifications of the reflection type polarizing member.

The polarizing beam splitter also called polarizing film may be obtained by forming a dielectric multilayer film, a dielectric high-reflection film or a cut filter on the first prism or on the second prism. It is to be noted that, usually in a polarizing beam splitter, the refraction angle or the incoming angle to the multilayer film and the substrate (first prism or second prism) is set so that the incoming angle to an interface may coincide with the Brewster angle. For example, the lamination structure of the bottom face of the first prism/polarizing beam splitter/bottom face of the second prism can be obtained by securing the bottom face of the first prism, the polarizing beam splitter and the bottom face of the second prism using, for example, a bonding agent.

The light reflecting member, first light reflecting member and second light reflecting member (which may be hereinafter referred to generally as “light reflecting members”) may be formed from a reflection enhancing film. Here, the reflecting enhancing film may be, for example, a silver reflection enhancing film having a structure wherein a silver reflecting film, a low-refraction factor film and a high-refraction factor film are laminated one on another. Or, a dielectric multilayer reflection film having a structure wherein a low-refraction factor thin film of SiO₂ or the like and a high-refraction factor thin film of TiO₂ or Ta₂O₅ are laminated successively in several tens layers or more or a reflection film of the organic high molecular multilayer thin film type produced by similarly laminating polymer films of a thickness of the submicron order having different refraction factors may be used. Or else, the light reflecting members may be formed from a metal layer such as a silver layer, a chromium layer or an aluminum layer, or an alloy layer. The method of providing the light reflecting members may be, where the light reflecting members are in the form of a sheet, a film or a plate, a method which uses a bonding agent, a fastening method which uses a screw, a fixing method using ultrasonic bonding or a method which uses a pressure sensitive adhesive. Where the light reflecting members are in the form of a thin film, known methods such as a PVD method or a CVD method such as vacuum vapor deposition or sputtering may be used.

The quarter-wave plate may be a known quarter-wave plate produced from birefringent crystal such as quartz or calcite or another known quarter-wave plate produced from a plastic material. In order to provide or dispose the quarter-wave plate, for example, a bonding agent may be used.

The material for forming the light diffusing member in the form of a sheet or a film may be a polycarbonate resin (PC), a polystyrene-based resin (PS) or a methacrylate resin. The light diffusing member can be obtained by working the surface of a material in the form of a sheet or a film made of any of such resins as mentioned above into a textured face, that is, a finely convex and concave face, for example, by sandblasting. Or, the light diffusing member can be obtained by applying a light diffusing agent to the surface of a material in the form of a sheet or a film made of any of the resins. Here, the light diffusing agent is particles which have a property of diffusing light from a light source and are formed from inorganic material particles or organic material particles. The inorganic material which forms inorganic material particles may particularly be silica, aluminum hydroxide, aluminum oxide, titanium oxide, zinc oxide, barium sulfate, magnesium silicate or a mixture of such materials. On the other hand, the resin which forms the organic material particles may be an acrylic-based resin, an acrylonitrile-based resin, a polyurethane-based resin, a polyvinylchloride-based resin, a polystyrene-based resin, a polyacrylonitrile-based resin, a polyamide-based resin, a polysiloxane-based resin or a melamine-based resin. The shape of the light diffusing agent may be, for example, a spherical shape, a cubic shape, a needle shape, a bar shape, a spindle shape, a plate shape, a squamous shape or a fiber shape. The method of providing the light diffusing member may be a method of attaching the light diffusing member to the reflection type polarizing member using a bonding agent or an adhesive sheet. Or, a method of applying the light diffusing agent to the reflection type polarizing member may be used as the method of providing the light diffusing member.

The first and second prisms may be produced from known optical glass. Further, each of the first and second prisms may be formed from a combination of a plurality of prisms. In other words, a plurality of prisms may be adhered to each other, for example, by a bonding agent to produce a prism. It is to be noted that the angle defined by the two inclined faces of the triangular prism need not be 90 degrees. It is important to form the triangular prism such that a light beam enters the triangular prism and is then reflected and refracted by the triangular prism and thereafter passes a predetermined optical plane such that, even if light of a P polarized light component and light of an S polarized light component separated by the beam splitter advance along different light paths, they go out substantially in the same direction from the first inclined face of the second prism. As occasion demands, a portion at which an inclined face and the bottom face of the prism intersect with each other and a portion at which the two inclined faces of the prism intersect with each other may be formed not from a ridgeline but from a flat face or a curved face. The light diffusing layer may be formed at a portion of the face of the first prism, that is, the first inclined face, opposing to the light emitting element.

The plate-formed member may be a transparent material with respect to light emitted from the light emitting diode such as, for example, glass, a plastic material such as, for example, a methacrylate resin, a polycarbonate resin (PC), an acrylic-based resin, an amorphous polypropylene-based resin, a styrene-based resin including an AS (Acrylonitrile Styrene Copolymer) resin, a polyethylene terephthalate (PET) resin, or a polyester-based resin such as a polybutylene terephthalate (PBT) resin.

The three-dimensional image display apparatus according to the embodiments of the present invention including the preferred forms and configurations described above may further include light detection means configured to measure the light intensity of the light beams successively emitted from the planar light emitting members. Further, the light emitting state of the planar light emitting members may be controlled based on a result of the measurement of the light intensity by the light detection means, or the operation state of the optical modulation means or the two-dimensional image forming apparatus may be controlled based on a result of the measurement of the light intensity by the light detection means.

The light detection means may be formed from a photodiode, a CCD (Charge Coupled Device) or a CMOS (Complementary Metal Oxide Semiconductor) sensor. A beam splitter or a partially reflecting mirror or partial reflector may be disposed between the light source and the optical modulation means or two-dimensional image forming apparatus such that part of light incoming from the light source to the optical modulation means or two-dimensional image forming apparatus is extracted and introduced to the light detection means. Or, a partially reflecting mirror may be disposed rearwardly of the Fourier transform image forming means or two-dimensional image forming apparatus such that part of light outgoing from the Fourier transform image forming means or two-dimensional image forming apparatus is extracted and introduced to the light detection means. Or, the light detection means may be attached to the optical modulation means or two-dimensional image forming apparatus. Or else, the light detection means may be incorporated in the planar light emitting members. In particular, the light detection means may be disposed in the proximity of each of the light emitting elements which form the planar light emitting members or may be incorporated in the light emitting elements. Or, the light detection means may be disposed at a position at which it does not intercept light which is emitted from the light source and passes an effective region in which it enters the optical modulation means or two-dimensional image forming apparatus, Fourier transform image forming means or succeeding state.

In the three-dimensional image display apparatus according to the embodiments of the present invention including the preferred forms and configurations described above, although the numbers of U₀ and V₀ are not limited particularly, they may be 4≦U₀≦12, preferably, for example, 9≦U₀≦11, or 4≦V₀≦12, preferably, for example, 9≦V₀≦11. The values of U₀ and V₀ may be equal to each other or may be different from each other. It is to be noted that a plane on which Fourier transform images are formed by the Fourier transform image forming means, that is, an XY plane, is hereinafter referred to sometimes as “image forming plane”.

In a preferred form of the three-dimensional image display apparatus according to the present invention, a Fourier transform image corresponding to a desired diffraction order is selected by the Fourier transform image selection means or spatial filter or passes through the Fourier transform image selection means or spatial filter. However, the desired diffraction order here may be the 0th diffraction order although it is not restricted to this.

In the three-dimensional image display apparatus according to the embodiments of the present invention including the preferred forms and configurations described above, an illuminating optical system for shaping illuminating light may be disposed between the light source and the optical modulation means or two-dimensional image forming apparatus. In particular, a lens, for example, a collimator lens, is disposed between the light source and the optical modulation means or two-dimensional image forming apparatus, and the light source is positioned on the front side focal plane of the lens, or in the proximity of the front side focal plane. This is preferable because light or illuminating light outgoing from the lens becomes parallel light or substantially parallel light.

In a liquid crystal display apparatus which composes the two-dimensional spatial optical modulator or two-dimensional image forming apparatus, for example, a region within which transparent first and second electrodes described below overlap with each other and which includes a liquid crystal cell corresponds to one pixel. Then, the liquid crystal cell is caused to operate as a kind of light shutter or light valve to control the light transmission factor or numerical aperture of the pixel. Consequently, the light transmission factor of the illuminating light emitted from the planar light emitting members can be controlled to generally obtain a two-dimensional image as a whole. A rectangular aperture is provided in the overlapping region of the transparent first and second electrodes. When illuminating light emitted from the planar light emitting members passes through the apertures, Fraunhofer diffraction occurs for each pixel, and M×N sets of diffraction light are produced.

The liquid crystal display apparatus includes, for example, a front panel on which the transparent first electrodes are provided, a rear panel on which the transparent second electrodes are provided, and a liquid crystal material disposed between the front and rear panels. More particularly, the front panel includes, for example, a first substrate formed from a glass substrate or a silicon substrate, a transparent first electrode also called common electrode made of, for example, ITO (Indium Tin Oxide) and provided on the inner face of the first substrate, and a polarizing film provided on the outer face of the first substrate. Further, an orientation film is formed on the transparent first electrode. Meanwhile, the rear panel more particularly includes a second substrate formed, for example, from a glass substrate or a silicon substrate, a switching element formed on the inner face of the second substrate, a transparent second electrode also called pixel electrode made of, for example, ITO and controlled between conducting and non-conducting states by the switching element, and a polarizing film provided on the outer face of the second electrode. An orientation film is formed over an overall area including the transparent second electrode. The various members and the liquid crystal material which compose the liquid crystal display apparatus of the transmission type may be formed from known members and material. It is to be noted that the switching element may be a three-terminal element such as a MOS (Metal Oxide Semiconductor) type FET (Field Effect Transistor) or a thin film transistor (TFT) or a two-terminal element such as an MIM (Metal Insulation Metal) element, a barrister element or a diode formed on a single crystal silicon semiconductor substrate. Or, the liquid crystal display apparatus may have a matrix electrode configuration wherein a plurality of scanning electrodes extend in a first direction and a plurality of data electrodes extend in a second direction. In a liquid crystal display apparatus of the transmission type, illuminating light from the planar light emitting members comes in from the second substrate and goes out from the first substrate. On the other hand, in a liquid crystal display apparatus of the reflection type, illuminating light from the planar light emitting members comes in from the first substrate and is reflected by the second electrode or pixel electrode, for example, formed on the inner face of the second substrate and then goes out from the first substrate. The apertures can be obtained, for example, by forming an insulating material layer opaque to the illuminating light from the planar light emitting members between the transparent second electrode and the orientation film and then forming apertures in the insulating material layer. It is to be noted that, as the liquid crystal display apparatus of the reflection type, a liquid crystal display apparatus of the LCos (Liquid Crystal on Silicon) type.

In the three-dimensional image display apparatus according to the embodiments of the present invention, where the number P×Q of pixels of a two-dimensional image is represented by (P, Q), the value of (P, Q) may be the VGA (640, 480), S-VGA (800, 600), XGA (1,024, 768), APRC (1,152, 900), S-XGA (1,280, 1,024), U-XGA (1,600, 1,200), HD-TV (1,920, 1,080), or Q-XGA (2,048, 1,536) or any of several other resolutions for image display such as (1,920, 1,035), (720, 480), or (1,280, 960). However, the number is not particularly limited to any one of the values listed above.

In the three-dimensional image display apparatus according to the first or second embodiment of the present invention, a two-dimensional image is produced based on each of light beams or illuminating light beams successively emitted from the planar light emitting members by the optical modulation means or two-dimensional image forming apparatus. Further, spatial frequencies of the thus produced two-dimensional images are emitted along a plurality of diffraction angles corresponding to different diffraction orders from the pixels. Then, the spatial frequencies are Fourier transformed by the Fourier transform image forming means or first lens to produce and form a number of Fourier transform images or diffraction light beams corresponding to the number of diffraction orders. The thus formed Fourier transform images finally come to the observer. The images finally coming to the observer include components of the light or illuminating light in the incoming direction to the optical modulation means or two-dimensional image forming apparatus. Then, as such operations as described above are successively repeated in a time series, a group of light beams, that is, U₀×V₀ light beams, emitted from the Fourier transform image forming means or first lens can be produced and scattered in a spatially high density and in a state wherein they are distributed in a plurality of directions. By such a group of light beams as just described, a stereoscopic image having a quality feeling proximate to that in the real world which has not been achieved in related art can be obtained based on the light beam reproduction method, which efficiently controls directional components of light beams for forming a stereoscopic image, without increasing the overall size of the three-dimensional image display apparatus.

Besides, since each light beam or illuminating light beam is emitted not in the form of a spot but in the form of a plane from the light source or each planar light emitting member, images formed rearwardly of the Fourier transform image forming means or first lens do not look in a spatially wafting state and in a state wherein they are arrayed as bright points in a two-dimensional matrix but are observed as planar images formed from rectangular regions connected to each other. Accordingly, the line of sight of the observer is less likely to be naturally led to the planar images, and such a problem that a stereoscopic image cannot be observed readily is less likely to occur. Furthermore, a stereoscopic image can be obtained without using a diffusion screen or the like.

Further, if the three-dimensional image display apparatus of the embodiments of the present invention form a stereoscopic image, for example, based on 0th-order diffraction light, then a bright and clear stereoscopic image of high quality can be obtained.

Further, where the light detection means is provided, the light emitting state of the planar light emitting members can be supervised. Consequently, occurrence of quality deterioration of an image arising from a dispersion of the light emitting state or a secular change of the planar light emitting members can be suppressed.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view showing a three-dimensional image display apparatus according to a working example 1 of the present invention on a yz plane;

FIG. 2 is a schematic perspective view of the three-dimensional image display apparatus of the working example 1 as viewed in an oblique direction;

FIG. 3 is a schematic perspective view illustrating arrangement of components of the three-dimensional image display apparatus of the working example 1;

FIG. 4 is a schematic view showing part of the three-dimensional image display apparatus of the working example 1 in an enlarged scale;

FIGS. 5A and 5B are schematic views illustrating production of a plurality of diffraction light beams of different diffraction orders by optical modulation means or two-dimensional image forming apparatus in the three-dimensional image display apparatus of the working example 1;

FIG. 6 is a schematic front elevational view of a light source of the three-dimensional image display apparatus of the working example 1;

FIG. 7 is a schematic front elevational view of a spatial filter of the three-dimensional image display apparatus of the working example 1;

FIGS. 8A to 8D are schematic sectional views showing different forms of a planar light emitting member of the three-dimensional image display apparatus of the working example 1 and FIG. 8E is a schematic perspective view of a light source usable in the three-dimensional image display apparatus of the working example 1 as viewed in an oblique direction;

FIG. 9 is a timing chart illustrating timings of formation of two-dimensional images by the optical modulation means or two-dimensional image forming apparatus of the three-dimensional image display apparatus of the working example 1 and opening and closing timings of different apertures of Fourier transform image selection means or spatial filter of three-dimensional image display apparatus of the working example 1;

FIG. 10 is a perspective view schematically illustrating spatial filtering by the Fourier transform image selection means or spatial filter of the three-dimensional image display apparatus of the working example 1 in chronologic order;

FIG. 11 is a schematic view showing images obtained as a result of the spatial filtering illustrated in FIG. 10;

FIG. 12 is a schematic view illustrating part of a three-dimensional image display apparatus according to a working example 2 of the present invention on a yz plane;

FIG. 13 is a similar view but illustrating part of a three-dimensional image display apparatus according to a modification to the three-dimensional image display apparatus of the working example 2 on the yz plane;

FIG. 14 is a schematic view showing a three-dimensional image display apparatus according to a working example 3 of the present invention on a yz plane;

FIG. 15 is a similar view but illustrating a three-dimensional image display apparatus according to a modification to the three-dimensional image display apparatus of the working example 3 on the yz plane;

FIG. 16 is a block diagram illustrating a concept of a control circuit for controlling a two-dimensional image forming apparatus and a light source of the three-dimensional image display apparatus of the modification to the working example 3;

FIG. 17 is a schematic view showing a three-dimensional image display apparatus according to another modification to the three-dimensional image display apparatus of the working example 3;

FIG. 18 is a similar view but illustrating a three-dimensional image display apparatus according to a further modification to the three-dimensional image display apparatus of the working example 3;

FIG. 19 is a block diagram illustrating a concept of a control circuit for controlling a two-dimensional image forming apparatus to which light detection means is attached;

FIGS. 20A and 20B are schematic sectional views of a planar light emitting member of a three-dimensional image display apparatus according to a working example 4 of the present invention and FIG. 20C is a view illustrating a polarization state of light propagating along a rod integrator which forms the planar light emitting member;

FIGS. 21A and 21B are schematic sectional views of a planar light emitting member of a three-dimensional image display apparatus according to a working example 5 of the present invention and FIG. 21C is a view illustrating a polarization state of light propagating along a rod integrator which forms the planar light emitting member;

FIGS. 22A and 22B are schematic sectional views of modifications to the planar light emitting member of the working example 4 and FIGS. 22C and 22D are schematic sectional views of modifications to the planar light emitting member of the working example 5;

FIGS. 23A and 23B are schematic sectional views of the planar light emitting member of a working example 6;

FIGS. 24A, 24B and 24C are schematic sectional views showing a planar light emitting member of a three-dimensional image display apparatus according to a working example 7 and modified planar light emitting members, respectively;

FIG. 25 is a schematic view of a three-dimensional image display apparatus according to a modification to the working example 1 on a yz plane;

FIG. 26 is a schematic view showing, in an enlarged scale, part of the three-dimensional image display apparatus of FIG. 25 where a certain planar light emitting member is in a light emitting state;

FIG. 27 is a schematic view showing, in an enlarged scale, part of the three-dimensional image display apparatus of FIG. 25 where another planar light emitting member is in a light emitting state;

FIG. 28 is a schematic view showing, in an enlarged scale, part of the three-dimensional image display apparatus of FIG. 25 where a further planar light emitting member is in a light emitting state;

FIGS. 29A and 29B are schematic views showing part of further modifications to the three-dimensional image display apparatus of the working example 1 on a yz plane;

FIG. 30 is a schematic view showing part of a still further modifications to the three-dimensional image display apparatus of the working example 1 on a yz plane;

FIG. 31 is a schematic perspective view showing a three-dimensional image display apparatus of the multi-unit type wherein a plurality of three-dimensional image display apparatus of the working example 1 are combined; and

FIG. 32 is a schematic perspective view showing an example of a configuration of a three-dimensional image display apparatus in related art.

### DETAILED DESCRIPTION OF THE PREFERRED EMBODIMENTS

In the following, the present invention is described in connection with working examples thereof shown in the accompanying drawings.

### Working Example 1

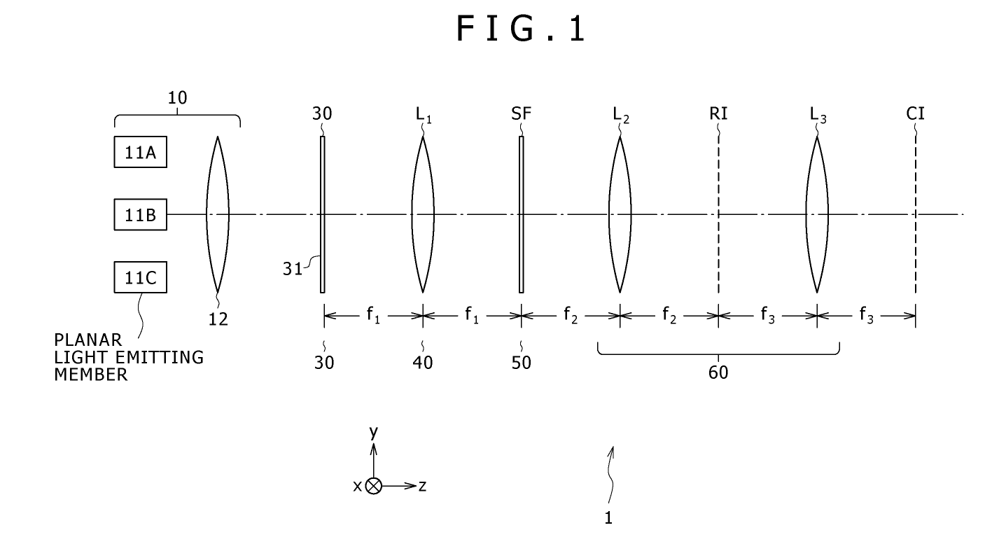

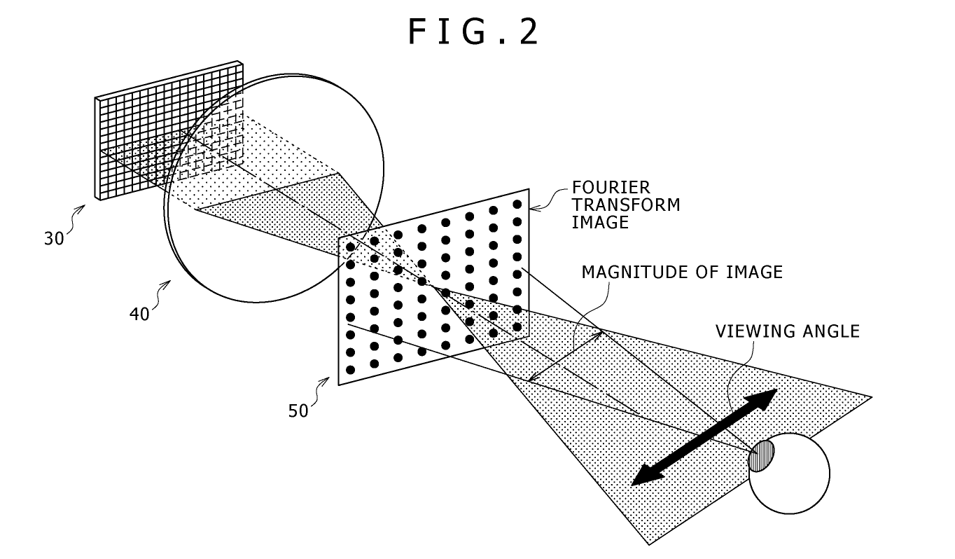

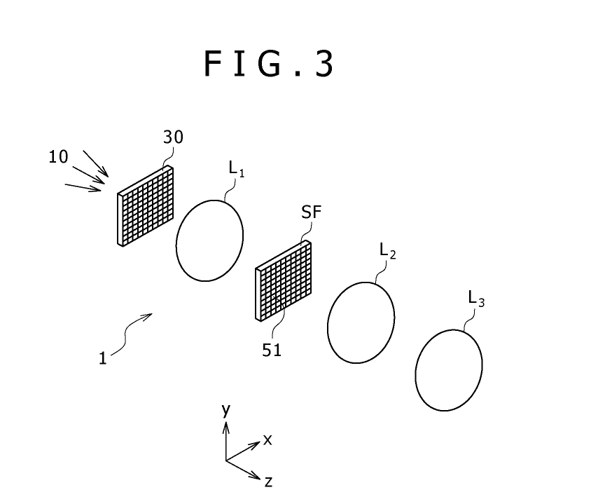

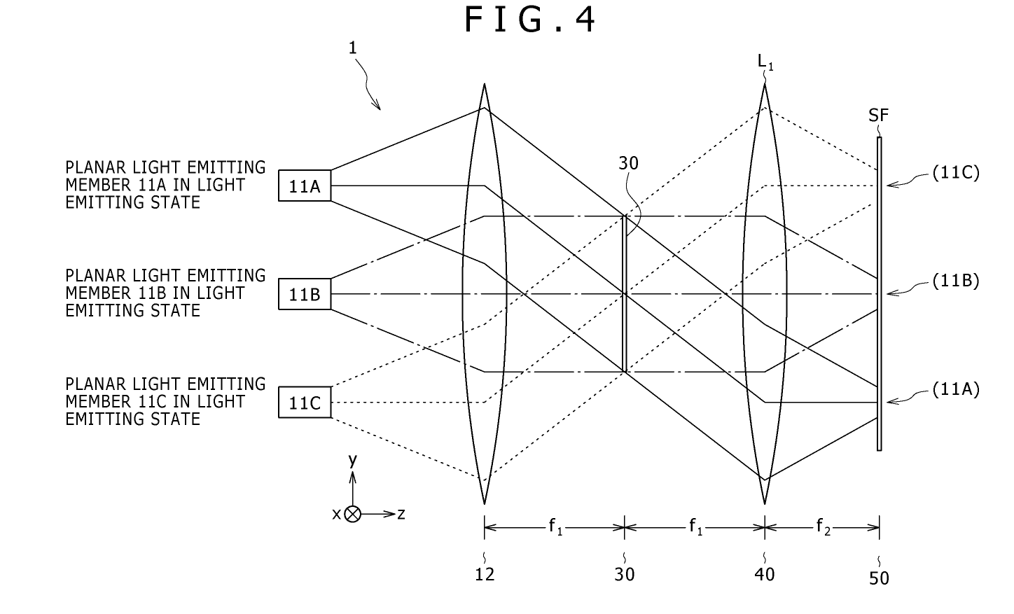

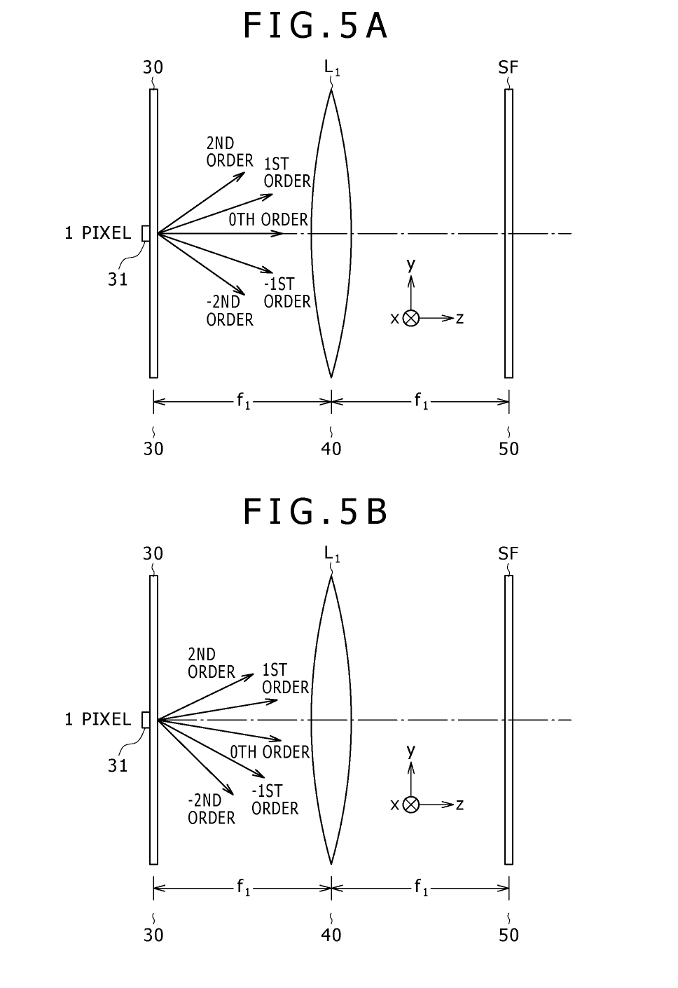

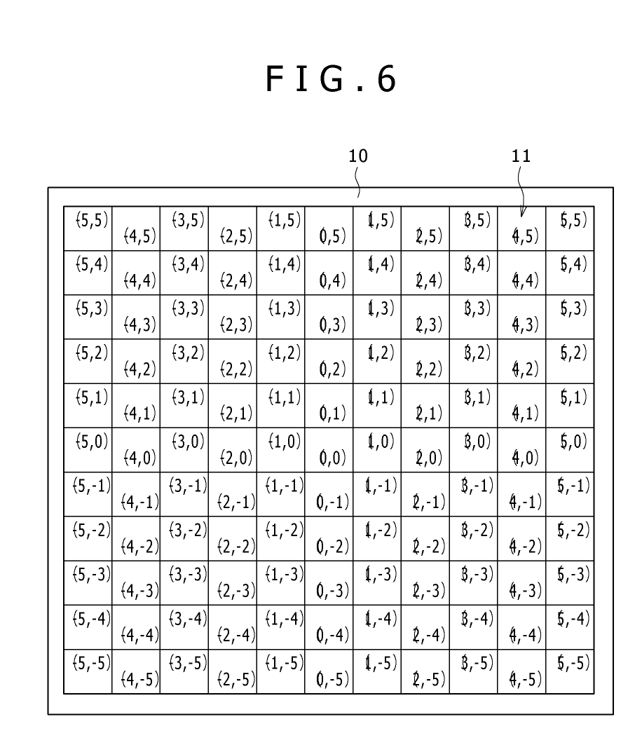

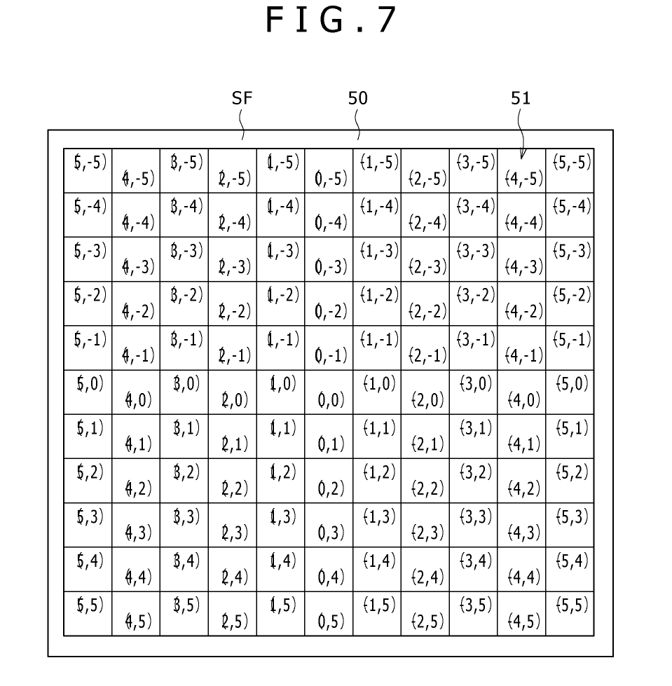

The working example 1 of the present invention is directed to three-dimensional image display apparatus according to first and second embodiments of the present invention. FIG. 1 shows the three-dimensional image display apparatus according to the working example 1 which displays a monochromatic image. It is to be noted that, in FIG. 1, the optical axis is set to a z axis, and Cartesian coordinates in a plane perpendicular to the z axis are taken on an x axis and a y axis. Further, the direction parallel to the x axis is represented as X direction and the direction parallel to the y axis is represented as Y direction. The X direction is taken, for example, as a horizontal direction of the three-dimensional image display apparatus, and the Y direction is taken, for example, as a vertical direction of the three-dimensional image display apparatus. Here, FIG. 1 is a schematic view showing the three-dimensional image display apparatus of the working example 1 on the yz plane. Also where the three-dimensional image display apparatus of the working example 1 is viewed on the xz plane, it exhibits a schematic view substantially similar to that of FIG. 1. Meanwhile, FIG. 2 schematically shows the three-dimensional image display apparatus of the working example 1 as viewed in an oblique direction, and FIG. 3 schematically illustrates an arrangement state of components of the three-dimensional image display apparatus of the working example 1. It is to be noted that, in FIG. 2, most of the components of the three-dimensional image display apparatus are omitted and also light beams are shown in a simplified form, different from FIGS. 1 and 3. Further, in FIG. 2, only part of light beams emitted from a two-dimensional image display apparatus are shown. Further, several elements in the proximity of optical modulation means [two-dimensional image forming apparatus], Fourier transform image forming means [first lens] and Fourier transform image selection means [spatial filter] are shown in an enlarged scale in FIGS. 4, 5A and 5B, respectively. Further, a front elevation of a light source is schematically shown in FIG. 6 and a front elevation of a spatial filter is schematically shown in FIG. 7.

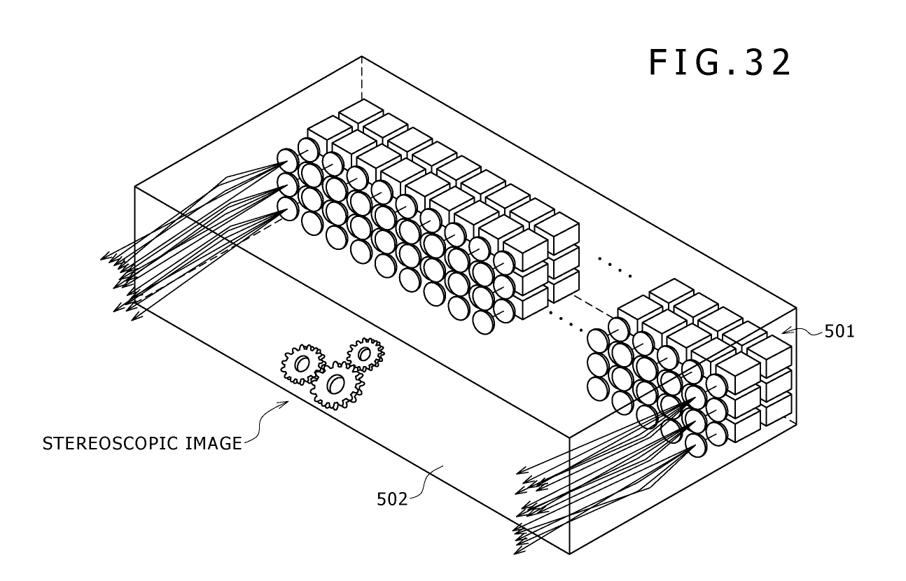

In display of a stereoscopic image according to a light beam reproduction method in related art, in order to emit a plurality of light beams of light from a virtual origin on the surface of a virtual physical solid existing at an arbitrary position, it is necessary to prepare in advance an apparatus which can provide beams of light which are emitted at various angles. For example, in the apparatus shown in FIG. 32, a large number of, for example, U₀×V₀, projector units 501 need to be disposed parallelly in a horizontal direction and a vertical direction.

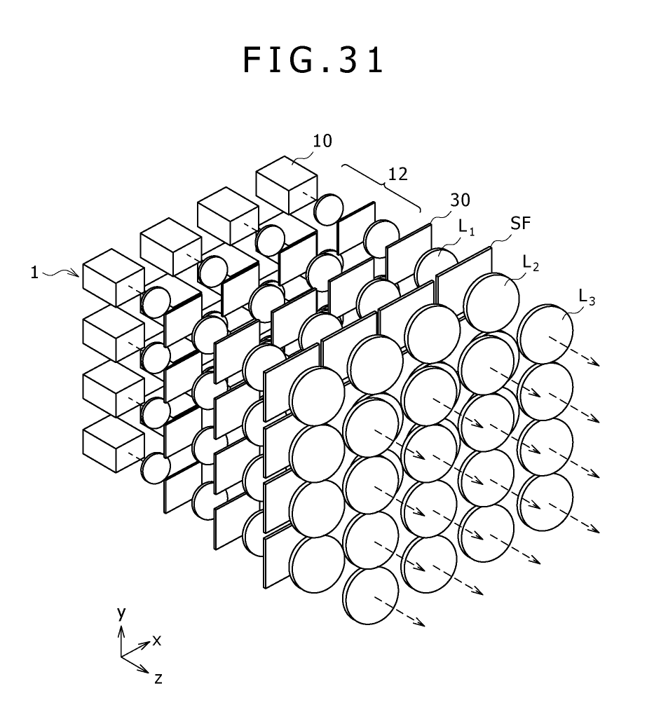

Meanwhile, in the three-dimensional image display apparatus 1 of the working example 1, the three-dimensional image display apparatus itself which includes such components as seen in FIG. 1 and so forth can generate and form a greater amount of light beams having a higher spatial density when compared with the apparatus in related art. The three-dimensional image display apparatus 1 of the working example 1 has functions equivalent to those of the apparatus shown in FIG. 32 which includes a large number of, U₀×V₀, projector units 501 disposed parallelly in a horizontal direction and a vertical direction. It is to be noted that, for example, where it is intended to employ a multi-unit system, only it is necessary to dispose a number of three-dimensional image display apparatus 1 of the working example 1 equal to the number of divisional three-dimensional images as seen from FIG. 31. In FIG. 31, the image display apparatus shown includes 4×4=16 three-dimensional image display apparatuses 1 of the working example 1.

Where the three-dimensional image display apparatus 1 of the working example 1 of the present invention is described in connection with components of the three-dimensional image display apparatus according to the first embodiment of the present invention, the three-dimensional image display apparatus 1 includes:

(A) a light source 10 including U₀×V₀ planar light emitting members 11 disposed in a two-dimensional matrix wherein U₀ and V₀ planar light emitting members 11 are arrayed in X and Y directions, respectively;

(B) optical modulation means 30 having a plurality of (P×Q) pixels 31 for modulating light (illuminating light) successively outputted from the planar light emitting members 11 by means of each of the pixels 31 to produce a two-dimensional image and emitting spatial frequencies of the produced two-dimensional image along a plurality of (totaling M×N) diffraction angles corresponding to different diffraction orders produced from the pixels 31;

(C) Fourier transform image forming means 40 for Fourier transforming the spatial frequencies of the two-dimensional image emitted from the optical modulation means 30 to produce a number of Fourier transform images corresponding to the number (totaling M×N) of diffraction orders and forming the Fourier transform images; and

(D) conjugate image forming means 60 for forming conjugate images of the Fourier transform images formed by the Fourier transform image forming means 40.

Meanwhile, where the three-dimensional image display apparatus 1 of the working example 1 of the present invention is described in connection with components of the three-dimensional image display apparatus according to the second embodiment of the present invention, the three-dimensional image display apparatus 1 of the working example 1 includes:

(A) a light source 10 including U₀×V₀ planar light emitting members 11 disposed in a two-dimensional matrix wherein U₀ and V₀ planar light emitting members 11 are arrayed in X and Y directions, respectively;

(B) a two-dimensional image forming apparatus 30 having (P×Q) apertures arrayed in a two-dimensional matrix in the X and Y directions for controlling the passage of each of light beams (illuminating light beams) successively emitted from the planar light emitting members 11 for the individual apertures to produce a two-dimensional image and producing a plurality of (totaling M×N) diffraction light beams of different diffraction orders for the individual apertures based on the two-dimensional image;

(C) a first lens L₁ having a front side focal plane (focal plane on the light source side) on which the two-dimensional image forming apparatus 30 is disposed;

(D) a second lens L₂ having a front side focal plane (focal plane on the light source side) positioned on a rear side focal plane (focal plane on the observer side) of the first lens L₁; and

(E) a third lens L₃ having a front side focal plane positioned on a rear side focal plane of the second lens L₂.

Here, the spatial frequency of the two-dimensional images corresponds to image information whose carrier frequency is the spatial frequency of the pixel structure.

The z axis which corresponds to the optical axis passes the center of the components of the three-dimensional image display apparatus 1 of the working example 1 and besides intersects perpendicularly with the components of the three-dimensional image display apparatus 1. If the components of the three-dimensional image display apparatus according to the first embodiment of the present invention and the components of the three-dimensional image display apparatus according to the second embodiment of the present invention are compared with each other, then the optical modulation means 30 corresponds the two-dimensional image forming apparatus 30; the Fourier transform image forming means 40 corresponds to the first lens L₁; Fourier transform image selection means 50 hereinafter described corresponds to a spatial filter SF; inverse Fourier transform means corresponds to the second lens L₂; and the conjugate image forming means 60 corresponds to the second lens L₂ and the third lens L₃. Therefore, for the convenience of description, the following description is given using the terms of the two-dimensional image forming apparatus 30, first lens L₁, spatial filter SF, second lens L₂ and third lens L₃.

In the working example 1, the particular number of planar light emitting members 11 arrayed in a two-dimensional matrix is U₀×V₀=11×11, and the numbers P and Q are P=1,024 and Q=768, respectively. It is to be noted, however, that the numbers of the planar light emitting members are not limited to the specific numbers. A collimator lens 12 is disposed between the light source 10 and the two-dimensional image forming apparatus 30. The planar light emitting members 11 are disposed on or in the proximity of a front side focal plane of the collimator lens 12 so that the outgoing direction of light incoming to the collimator lens 12 and outgoing in the form of parallel light from the collimator lens 12 can be changed stereoscopically by the collimator lens 12. Consequently, the incoming direction of the light (illuminating light) incoming to the optical modulation means or two-dimensional image forming apparatus 30 can be changed stereoscopically (refer to FIG. 4). It is to be noted that, while the outgoing directions of light beams emitted from the planar light emitting members 11 are same as each other or more particularly are parallel directions to each other and to the optical axis, they may otherwise be different from each other.

Referring to FIG. 7, in the working example 1, the spatial filter SF has U₀×V₀ apertures 51. Each aperture 51 can be controlled between open and closed states. The spatial filter SF having the apertures 51 controllable between open and closed states is formed from a liquid crystal display apparatus, or more particularly, a liquid crystal display apparatus of the transmission type. In the spatial filter SF having the apertures 51 controllable between the open and closed states, a desired one or ones of the apertures 51 are placed into an open state in synchronism with a production timing of a two-dimensional image by the two-dimensional image forming apparatus 30. By such opening control of the apertures 51, a Fourier transform image or diffraction light beam corresponding to a desired diffraction order can be selected. The apertures 51 are each formed at a position at which a desired Fourier transform image or diffraction light beam from among Fourier transform images or diffraction light beams obtained by the first lens L₁ are to be formed. Further, the position of each of the apertures 51 corresponds to a position at which a planar light emitting member 11 is disposed. Here, the planar shape of the apertures 51 of the spatial filter SF may be determined based on the shape of the Fourier transform images. Meanwhile, the size of the apertures 51 is substantially equal to the size of the Fourier transform images formed on the Fourier transform image selection means 50 or equal to the size of the two-dimensional images produced by the two-dimensional image forming apparatus 30 and formed on the spatial filter SF. Further, the angle θ to the observer of the width of a gap existing between adjacent ones of the apertures 51, that is, the distance between adjacent edges of adjacent ones of the apertures 51, is very close to 0 radians.

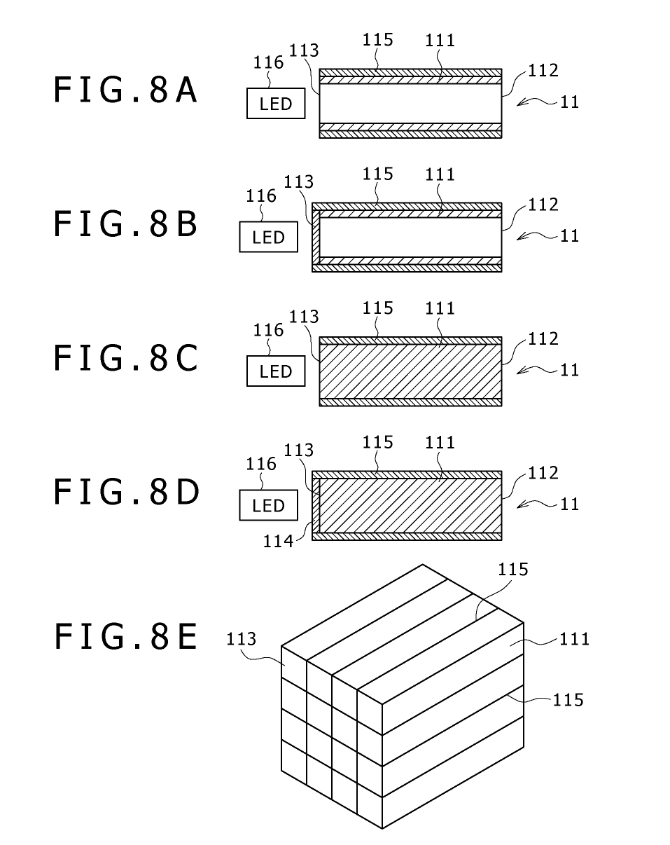

Referring to FIGS. 8A to 8E, each planar light emitting member 11 includes a rod integrator 111 which emits light from a first end face 112 thereof, and a light emitting diode 116 disposed adjacent a second end face 113 of the rod integrator 111. The rod integrator or kaleidoscope 111 has a rectangular section when it is taken along a virtual plane perpendicular to an axial line thereof. As seen from a schematic sectional view shown in FIG. 8A, the rod integrator 111 is formed from a hollow member which is open at the first and second end faces 112 and 113 thereof. Or, as seen from a schematic sectional view shown in FIG. 8B, the planar light emitting member 11 is formed from a hollow member which is open at the first end face 112 thereof but has a light diffusing face as the second end face 113. Or else, as seen from a schematic sectional view shown in FIG. 8C, the planar light emitting member 11 is formed from a solid member made of a transparent material. Or otherwise, the planar light emitting member 11 is formed from a solid member having a light diffusing layer 114 formed on the second end face 113 thereof. It is to be noted that a light reflecting layer 115 formed from an aluminum layer formed by vapor deposition is provided on the outer face of such a hollow member or a solid member as described above. The rod integrator 111 is made of glass. It is to be noted that a binding means (not shown) may be used to bind U₀×V₀ planar light emitting members 11 arrayed without a gap left therein in a two-dimensional matrix to obtain a light source 10 as seen in FIG. 8E. It is to be noted that, in FIG. 8E, 4×4 planar light emitting members are shown.

A state wherein light fluxes emitted from planar light emitting members 11A, 11B and 11C which form the light source 10 pass the two-dimensional image forming apparatus 30, first lens L₁ and spatial filter SF is schematically illustrated in FIG. 4. Referring to FIG. 4, the light flux emitted from the planar light emitting member 11A of the light source 10 is indicated by solid lines, and the light flux emitted from the planar light emitting member 11B is indicated by alternate long and short dash lines while the light flux emitted from the planar light emitting member 11C is indicated by broken lines. Further, the positions of images on the spatial filter SF formed from illuminating light emitted from the planar light emitting members 11A, 11B and 11C are represented by reference characters 11A, 11B and 11C, respectively. It is to be noted that the position numbers (hereinafter described) of the planar light emitting members 11A, 11B and 11C which form the light source 10 are, for example, (5, 0), (0, 0) and (−5, 0). Here, if a certain one of the planar light emitting members is in a turned on state, that is, in a light emitting state, then all of the other light emitting members are in a turned off state, that is, in a no-light emitting state.

As described hereinabove, the collimator lens 12 is disposed between the planar light emitting members 11 and the two-dimensional image forming apparatus 30. The two-dimensional image forming apparatus 30 is illuminated with illuminating light beams emitted from the planar light emitting members 11 and passing through the collimator lens 12. However, the incoming direction of the illuminating light beams to the two-dimensional image forming apparatus 30 differs stereoscopically depending upon the two-dimensional positions (light emitting positions) of the planar light emitting members 11. In other words, the optical modulation means or two-dimensional image forming apparatus 30 is illuminated with the illuminating light beams successively emitted from different light emitting positions of the light source 10 and having different incoming directions.

The optical modulation means 30 is formed from a two-dimensional spatial optical modulator having a plurality of, particularly P×Q, pixels 31 arrayed two-dimensionally, and each of the pixels 31 has an aperture. Here, the two-dimensional spatial optical modulator or two-dimensional image forming apparatus 30 is particularly formed from a liquid crystal display apparatus of the transmission type having P×Q pixels 31 disposed two-dimensionally, that is, disposed in a two-dimensional matrix along the X direction and the Y direction wherein P pixels 31 are disposed in the X direction and Q pixels 31 are disposed in the Y direction. Each of the pixels 31 has an aperture. It is to be noted that the shape of the aperture in plan is a rectangular shape. Where the apertures have a rectangular planar shape, Fraunhofer diffraction occurs and M×N diffraction light beams are produced. In particular, by such apertures, the amplitude or intensity of the incoming light waves is modulated periodically such that amplitude gratings from which a light amount distribution coincident with a light transmission factor distribution of gratings is obtained are formed.

One pixel 31 is formed from a region in which a transparent first electrode and a transparent second electrode overlap with each other and which includes a liquid crystal cell. The liquid crystal cell operates as a kind of optical shutter or light valve, that is, the light transmission factor of each pixel 31 is controlled, to control the light transmission factor of the illuminating light emitted from the planar light emitting members 11 of the light source 10, and as a whole, a two-dimensional image can be obtained. A rectangular aperture is provided in the overlapping region of the transparent first and second electrodes, and when the illuminating light emitted from the planar light emitting members 11 passes through the aperture, Fraunhofer diffraction occurs. As a result, M×N diffraction light beams are generated from each of the pixels 31. In other words, since the number of pixels 31 is P×Q, it is considered that totaling P×Q×M×N diffraction light beams are generated. Or, as a whole, the number of Fourier transform images formed from light beams from the light source 10 is P×Q×U₀×V₀. In the two-dimensional image forming apparatus 30, spatial frequencies of two-dimensional images are emitted along diffraction angles corresponding to a plurality of diffraction orders, totaling M×N diffraction orders, generated from each pixel 31. It is to be noted that the diffraction angles differ also depending upon the spatial frequencies of the two-dimensional images.

The Fourier transform images obtained based on the illuminating light beams emitted from the planar light emitting members 11 are formed, for example, in a rectangular shape on the spatial filter SF by the first lens L₁ corresponding to the individual positions of the planar light emitting members 11. Then, U₀×V₀ Fourier transform images finally pass through the spatial filter SF.

In the three-dimensional image display apparatus 1 of the working example 1, the Fourier transform image forming means 40 is formed from a lens, that is, the first lens L₁, and the optical modulation means 30 is disposed on the front side focal plane of this lens, that is, the first lens L₁.

The three-dimensional image display apparatus 1 of the working example 1 includes Fourier transform image selection means 50 for selecting a Fourier transform image corresponding to a desired diffraction order from among a number of generated Fourier transform images corresponding to a plural number of diffraction orders. Here, the Fourier transform image selection means 50 is disposed at a position at which Fourier transform images are formed, that is, at a position on an XY plane or an image forming plane on which Fourier transform images are formed by the Fourier transform image forming means 40. In particular, the Fourier transform image selection means 50 is disposed on the rear side focal plane, that is, on the focal plane on the observer side, of a lens which forms the Fourier transform image forming means 40, that is, the first lens L₁. Or, in other words, the three-dimensional image display apparatus 1 of the working example 1 includes a spatial filter SF having U₀×V₀ apertures 51, which can be controlled between opened and closed states, and positioned on the rear side focal plane of the first lens L₁. In particular, the Fourier transform image selection means 50 or spatial filter SF has U₀×V₀ apertures 51.

Here, the Fourier transform image selection means 50 or spatial filter SF can be formed more particularly from a liquid crystal display apparatus of the transmission type or the reflection type which uses ferroelectric liquid crystal having, for example, U₀×V₀ pixels or a MEMS (Micro Electro Mechanical Systems) of the two-dimensional type including an apparatus wherein movable mirrors are arrayed two-dimensionally. Here, for example, opening and closing control of the apertures 51 can be carried out by causing each liquid crystal cell to operate as a kind of optical shutter or light valve or by movement/non-movement of a movable mirror. In the Fourier transform image selection means 50 or spatial filter SF, a Fourier transform image corresponding to a desired diffraction order (0th order) can be selected by placing a desired aperture 51 (particularly an aperture 51 through which 0th order diffraction light beam is to pass) into an open state in synchronism with a production timing of a two-dimensional image by the optical modulation means or two-dimensional image forming apparatus 30.

The three-dimensional image display apparatus 1 further includes an inverse Fourier transform means, particularly the second lens L₂ hereinafter described, for inverse Fourier transforming a Fourier transform image formed by the Fourier transform image forming means 40 to form a real image RI of a two-dimensional image formed by the optical modulation means 30.

In the working example 1, each of the first lens L₁, second lens L₂ and third lens L₃ is particularly formed from a convex lens.

As described hereinabove, the two-dimensional image forming apparatus 30 is disposed on the front side focal plane, that is, the focal plane on the light source side, of the first lens L₁ having the focal distance f₁. Further, the spatial filter SF which can be temporally controlled to open and close for spatially and temporally filtering the Fourier transform images is disposed on the rear side focal plane, that is, the focal plane on the observer side, of the first lens L₁. Further, a number of Fourier transform images corresponding to a plural number of diffraction orders are produced by the first lens L₁, and the Fourier transform images are formed on the spatial filter SF. It is to be noted that, while 64 Fourier transform images are shown in the form of a dot for the convenience of illustration in FIG. 2, actually the Fourier transform images have a rectangular shape. Then, one of the large number of Fourier transform images shown in FIG. 2 is selected by passage thereof through an aperture 51, which is placed in an open state corresponding to a planar light emitting member 11.

A schematic front elevational view of the light source 10 formed from a plurality of planar light emitting members 11 arrayed in a two-dimensional matrix is shown in FIG. 6, and a schematic front elevational view of the spatial filter SF formed from a liquid crystal display apparatus is shown in FIG. 7. In FIGS. 6 and 7, numerical values (u, v) represent position numbers of the planar light emitting members 11 which compose the light source 10 or of the apertures 51 which compose the spatial filter SF. In particular, for example, to the (3, 2)th aperture 51, only a desired Fourier transform image, for example, a Fourier transform image corresponding to the 0th-order diffraction, of a two-dimensional image formed from the planar light emitting member 11 positioned at the (3, 2)th position comes in, and it passes through the (3, 2)th aperture 51. Fourier transform images other than the desired Fourier transform image of the two-dimensional image formed from the planar light emitting member 11 positioned at the (3, 2)th position are intercepted by the spatial filter SF. On the front side focal plane of the second lens L₂ having a focal distance f₂, the spatial filter SF is disposed. Further, the second lens L₂ and the third lens L₃ are disposed such that the rear side focal plane of the second lens L₂ and the front side focal plane of the third lens L₃ having a focal distance f₃ coincide with each other.

As described above, the conjugate image forming means 60 is particularly formed from the second lens L₂ and the third lens L₃. The second lens L₂ having the focal distance f₂ inverse Fourier transforms a Fourier transform image filtered by the spatial filter SF to form a real image RI of the two-dimensional image formed by the two-dimensional image forming apparatus 30. In particular, the second lens L₂ is disposed such that the real image RI of the two-dimensional image formed by the two-dimensional image forming apparatus 30 is formed on the rear side focal plane of the second lens L₂. The magnification of the real image RI obtained here with respect to the two-dimensional image of the two-dimensional image forming apparatus 30 can be varied by arbitrarily selecting the focal distance f₂ of the second lens L₂. Further, the third lens L₃ having the focal distance f₃ forms a conjugate image CI of the Fourier transform image filtered by the spatial filter SF.

Here, since the rear side focal plane of the third lens L₃ is a conjugate plane of the spatial filter SF, this is equivalent to that the two-dimensional image produced by the two-dimensional image forming apparatus 30 is outputted from a portion on the spatial filter SF corresponding to one of the apertures 51. Then, the amount of light beams to be produced and outputted finally corresponds to the number of pixels (P×Q) and to the number of light beams which pass through the spatial filter SF. In particular, the situation that the amount of light beams which pass through the spatial filter SF is decreased by later passage or reflection of the light through or by a component of the two-dimensional image display apparatus does not substantially occur. Further, although the conjugate image CI of the Fourier transform image is formed on the rear side focal plane of the third lens L₃, since directional components of the conjugate image of the two-dimensional image are defined by directional components of illuminating light beams emitted from the planar light emitting members 11 and incoming to the two-dimensional image forming apparatus 30, it can be regarded that the light beams are disposed regularly two-dimensionally on the rear side focal plane of the third lens L₃. In other words, this is generally equivalent to a state that a plurality of, particularly U₀×V₀, projector units 501 shown in FIG. 32 are disposed on the rear side focal plane of the third lens L₃, that is, the plane on which the conjugate image CI is formed.

As schematically shown in FIGS. 5A and 5B, totaling M×N diffraction light beams are produced along the X direction and the Y direction by one pixel 31 of the two-dimensional image forming apparatus 30. It is to be noted that, while only diffraction light beams including the 0th order light beam (n₀=0), ±first order light beams (n₀=±1) and ±second order light beams (n₀=±2) are illustrated representatively in FIGS. 5A and 5B, actually higher order (for example, ±fifth order) diffraction light beams are formed, and a stereoscopic image is finally formed based on part of such diffraction light beams, particularly, for example, based on the 0th order light beams. It is to be noted that FIG. 5A schematically illustrates diffraction light beams produced from a light beam emitted from the light emitting member 11B, and FIG. 5B schematically illustrates diffraction light beams formed from a light beam emitted from the light emitting member 11A. Here, on diffraction light beams or light fluxes of each diffraction order, all pixel information, that is, information of all pixels, of the two-dimensional images formed by the two-dimensional image forming apparatus 30 is intensified. A plurality of light beams produced by diffraction from the same pixel of the two-dimensional image forming apparatus 30 at the same time all have the same image information. In other words, in the two-dimensional image forming apparatus 30 formed from a liquid crystal display apparatus of the transmission type having P×Q pixels 31, illuminating light beams from the planar light emitting members 11 are modulated by the pixels 31 to produce two-dimensional images, and besides spatial frequencies of the produced two-dimensional images are emitted along diffraction angles corresponding to a plurality of, totaling M×N, diffraction orders produced from each pixel 31. In other words, a kind of M×N copies of a two-dimensional image are emitted along diffraction angles corresponding to a plurality of, totaling M×N, diffraction orders from the two-dimensional image forming apparatus 30.

The spatial frequencies of the two-dimensional images on which all image information of the two-dimensional images formed by the two-dimensional image forming apparatus 30 is intensified are Fourier transformed by the first lens L₁ to produce a number of Fourier transform images corresponding to a plural number of diffraction orders produced from each pixel 31. Then, only a predetermined Fourier transform image, for example, a Fourier transform image corresponding to the 0th order diffraction, from among the Fourier transform images, is permitted to pass through the spatial filter SF. Then, the selected Fourier transform image is inverse Fourier transformed by the second lens L₂ to form a real image RI of the two-dimensional image produced by the two-dimensional image forming apparatus 30. The real image of the two-dimensional image enters the third lens L₃, by which a conjugate image CI is formed. It is to be noted that, while the spatial frequencies of the two-dimensional image correspond to image information whose carrier frequency is the spatial frequency of the pixel structure, only a region of the image information whose carrier is a 0th order plane wave, that is, a region up to a spatial frequency equal to ½ the spatial frequency of the pixel structure in the maximum, is obtained as first order diffraction whose carrier frequency is the 0th order diffraction of the plane wave component, and the spatial frequencies lower than one half the spatial frequency of the pixel structure or aperture structure of the optical modulation means pass through the spatial filter SF. The conjugate images of the two-dimensional structure formed by the third lens L₃ in this manner do not include the pixel structure of the two-dimensional image forming apparatus 30, but include all spatial frequencies of the two-dimensional images produced by the two-dimensional image forming apparatus 30. Then, since Fourier transform images of the spatial frequencies of the conjugate images of the two-dimensional images are produced by the third lens L₃.

Now, the timings of opening and closing control of the apertures 51 of the spatial filter SF are described.

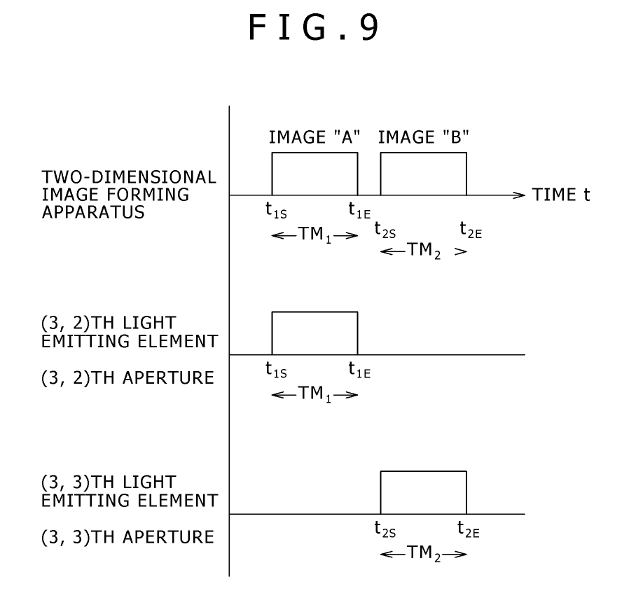

The spatial filter SF carries out opening and closing control of the apertures 51 in synchronism with image outputting of the two-dimensional image forming apparatus 30 in order to select a Fourier transform image corresponding to a desired diffraction order. This operation is described with reference to FIGS. 9, 10 and 11. It is to be noted that the uppermost stage of FIG. 9 illustrates a timing of outputting of an image from the two-dimensional image forming apparatus 30, and the middle stage of FIG. 9 illustrates opening and closing timings of the (3, 2)th aperture 51 of the spatial filter SF while the lowermost stage of FIG. 9 illustrates opening and closing timings of the (3, 3)th aperture 51.

It is assumed that, as seen in FIG. 9, in the two-dimensional image forming apparatus 30, an image “A” is displayed, for example, within a period TM₁ from time t_{1S} to time t_{1E}, and another image “B” is displayed within another period TM₂ from time t_{2S} to time t_{2E}. In this instance, in the light source 10, only the (3, 2)th planar light emitting member 11 is placed into a light emitting state within the period TM₁, and only the (3, 3)th planar light emitting member 11 is placed into a light emitting state within the period TM₂. In this manner, illuminating light beams successively emitted from the planar light emitting members 11 and having different incoming directions to the two-dimensional image forming apparatus 30 are used, and besides, such illuminating light beams are modulated by the individual pixels 31. Meanwhile, in the spatial filter SF, the (3, 2)th aperture 51 is placed into an open state within the period TM₁, and the (3, 3)th aperture 51 is placed into an open state within the period TM₂ as seen in FIG. 9. In this manner, different image information can be added to Fourier transform images, which are produced by the first lens L₁, as different diffraction order images from the same pixel 31 of the two-dimensional image forming apparatus 30. In other words, within the period TM₁, a Fourier transform image having the 0th diffraction order obtained at a certain pixel 31 of the two-dimensional image forming apparatus 30 by placing the (3, 2)th planar light emitting member 11 into a light emitting state includes image information relating to the image “A” and incoming direction information of the illuminating light to the two-dimensional image forming apparatus 30. On the other hand, within the period TM₂, a Fourier transform image having the 0th diffraction order obtained at the same certain pixel of the two-dimensional image forming apparatus 30 by placing the (3, 3)th planar light emitting member 11 into a light emitting state includes image information relating to the image “B” and incoming direction information of the illuminating light to the two-dimensional image forming apparatus 30.

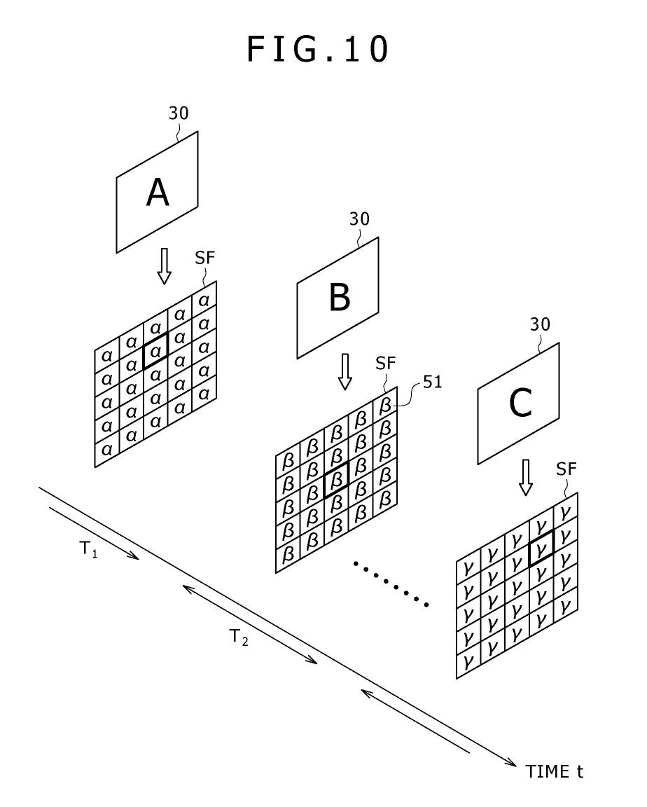

FIG. 10 schematically illustrates a timing of image formation and a timing of control of the apertures 51 on the two-dimensional image forming apparatus 30. Referring to FIG. 10, within the period TM₁, the two-dimensional image forming apparatus 30 displays the image “A”, and M×N Fourier transform images are condensed as Fourier transform images “α” on the corresponding (3, 2)th aperture 51 of the spatial filter SF. Within the period TM₁, since only the (3, 2)th aperture 51 is opened, only the Fourier transform image “α” having the 0th diffraction order passes through the spatial filter SF. Within the next period TM₂, the two-dimensional image forming apparatus 30 displays the image “B”, and M×N Fourier transform images are condensed similarly as Fourier transform images “β” on the corresponding (3, 3)th aperture 51 of the spatial filter SF. Within the period TM₂, since only the (3, 3)th aperture 51 is opened, only the Fourier transform image “β” having the 0th diffraction order passes through the spatial filter SF. Thereafter, opening and closing control of the apertures 51 of the spatial filter SF is carried out successively in synchronism with every image forming timing of the two-dimensional image forming apparatus 30. It is to be noted that, in FIG. 10, an aperture 51 in the open state is surrounded by solid lines while the apertures 51 in the closed state are surrounded by broken lines. Further, since the Fourier transform images “α”, “β” and “γ” which pass through the aperture 51 which is in an open state are images obtained based on the 0th diffraction order, they are bright. On the other hand, since the Fourier transform images “α”, “β” and “γ” which collide with the apertures 51 in the closed state are images obtained based on higher diffraction orders, they are dark. Accordingly, as occasion demands, the spatial filter SF is not necessary. If the space occupied by the spatial filter SF is watched for a certain period of time, then a state wherein U₀×V₀ rectangular images, that is, Fourier transform images, are juxtaposed in a two-dimensional matrix, that is, in a state similar to that shown in FIG. 2, would be observed.

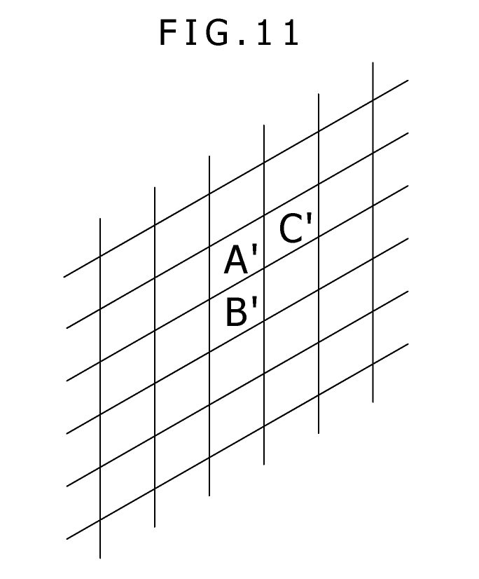

Images obtained as a final output of the three-dimensional image display apparatus where image formation and opening and closing control of the apertures 51 of the two-dimensional image forming apparatus 30 are carried out at such timings as described above are schematically shown in FIG. 11. Referring to FIG. 11, an image “A′” is obtained as a result of passage through the spatial filter SF only of a Fourier transform image “α” of the 0th order diffraction when the (3, 2)th planar light emitting member 11 is in a light emitting state because only the (3, 2)th aperture 51 is opened. Another image “B′” is obtained as a result of passage through the spatial filter SF only of another Fourier transform image “β” of the 0th order diffraction when only the (3, 3)th planar light emitting member 11 is in a light emitting state because only the (3, 3)th aperture 51 is opened. A further image “C′” is obtained as a result of passage through the spatial filter SF only of a further Fourier transform image “γ” of the 0th order diffraction when only the (4, 2)th planar light emitting member 11 is in a light emitting state because only the (4, 2)th aperture 51 is opened. It is to be noted that the image shown in FIG. 11 is an image observed by the observer. While, in FIG. 11, different images are partitioned by solid lines, such solid lines are virtual lines. Further, although actually such images as shown in FIG. 11 are obtained not at the same time, since the changeover time between images is very short, they are observed with the eyes of the observer as if they were displayed simultaneously. For example, selection of U₀×V₀ images based on illuminating light beams successively emitted from all of the planar light emitting members 11 is carried out within the display period of one frame. Further, although the images are shown displayed on a plane in FIG. 11, actually a stereoscopic image is observed by the observer.

In particular, for example, images “A′”, “B′”, . . . , “C′” are outputted in a time series from the rear side focal plane of the third lens L₃ as described hereinabove. This is equivalent as a whole to that a number of projector units shown in FIG. 32 equal to the number of planar light emitting members 11, particularly to U₀×V₀, are disposed on the rear side focal plane of the third lens L₃. Thus, an image “A′” is outputted from a certain projector unit and another image “B′” is outputted from another projector unit, whereafter a further image “C′” is outputted from a further projector unit in a time series. Then, if the two-dimensional image forming apparatus 30 reproduces images in a time series based on data, for example, of a large number of images of a certain physical solid picked up from various positions or angles or of images produced by a computer, then a stereoscopic image can be obtained based on the images.

The opening and closing control of the apertures 51 provided on the spatial filter SF need not be carried out for all apertures 51. In other words, the opening and closing control may be carried out, for example, for every other one of the apertures 51, or for only one or ones of the apertures 51 positioned at a predetermined position or positions.

As described above, with the three-dimensional image display apparatus 1 of the working example 1, a predetermined one of the planar light emitting members 11 is turned on to emit light while a desired one of the apertures 51 of the Fourier transform image selection means 50 or spatial filter SF is opened. Accordingly, spatial frequencies of two-dimensional images produced by the optical modulation means or two-dimensional image forming apparatus 30 are emitted along a plurality of diffraction angles corresponding to different diffraction orders and Fourier transformed by the Fourier transform image forming means 40 or first lens L₁. Then, the Fourier transform images obtained by the Fourier transform are spatially and temporally filtered by the Fourier transform image selection means 50 or spatial filter SF, and a conjugate image CI of the filtered Fourier transform image is formed. Consequently, the light beams can be produced and scattered in a spatially very high density and besides in a state distributed in a plurality of directions without increase of the overall size of the three-dimensional image display apparatus. Further, individual light beams which are components of the light beam group can be temporarily and spatially controlled independently of each other. Consequently, a stereoscopic image formed from light beams of quality proximate to that of a physical solid in the real world can be obtained. Further, since the lights or illuminating lights are emitted not in a spot-like state but in a planar state from the light source 10 or planar light emitting members 11, images formed rearwardly of the Fourier transform image forming means 40 or the first lens L₁ do not look in a spatially wafting state and in a state wherein they are formed from bright points arrayed in a two-dimensional matrix but are observed as planar images formed from rectangular regions connected to each other. Therefore, the line of sight of the observer is less likely to be naturally led to the planar images, and such a problem that a stereoscopic image may not be able to be observed readily is less likely to occur.

Further, with the three-dimensional image display apparatus 1 of the working example 1, since the light beam reproduction method is utilized, it is possible to provide a stereoscopic image which satisfies the visual sense functions such as focus adjustment, congestion and motion parallax. Further, with the three-dimensional image display apparatus 1 of the working example 1, since illuminating light beams having different incoming directions to the two-dimensional image forming apparatus 30 relying upon a plurality of planar light emitting members 11 are utilized efficiently, when compared with the image outputting techniques in related art, a number of light beams, which can be controlled by one image outputting device, that is, the two-dimensional image forming apparatus 30, equal to the number of planar light emitting members 11, that is, U₀×V₀ light beams, can be obtained. Besides, with the three-dimensional image display apparatus 1 of the working example 1, since filtering is carried out spatially and temporally, a temporal characteristic of the three-dimensional image display apparatus can be converted into a spatial characteristic of the three-dimensional image display apparatus. Further, a stereoscopic image can be obtained without using a diffusion screen or the like. Furthermore, a stereoscopic image which is appropriate for observation from any direction can be provided. Further, since light beams can be produced and scattered in a spatially high density, a spatial image of a high definition proximate to the limit to visual observation can be provided.

### Working Example 2

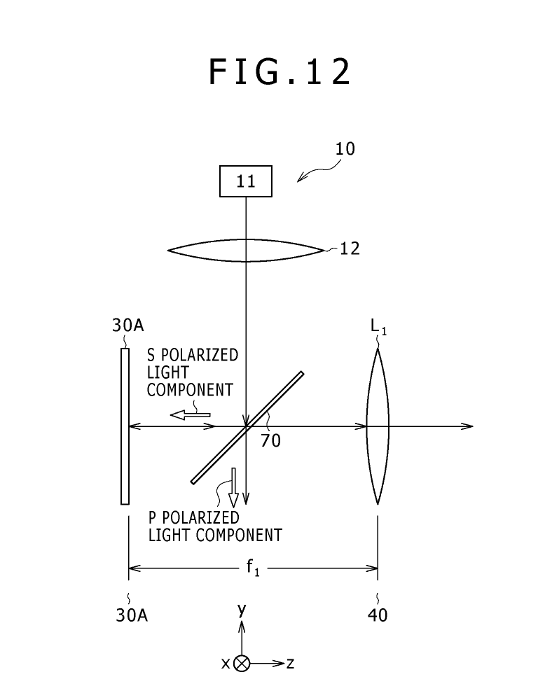

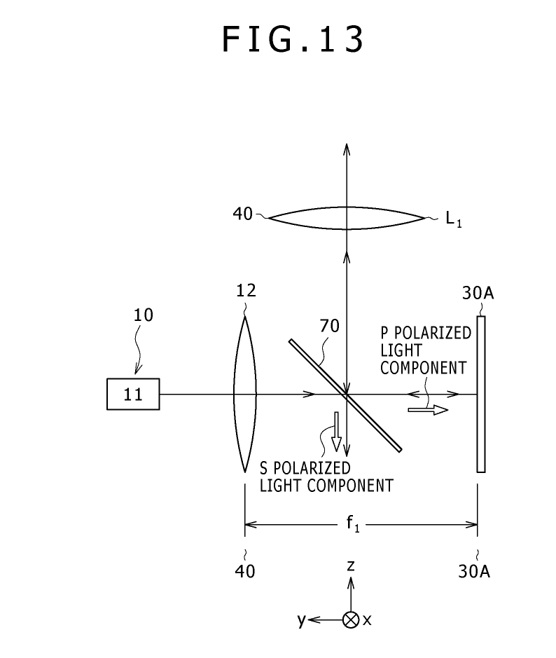

The working example 2 is a modification to the working example 1. Different three-dimensional image display apparatus according to the working example 2 are shown in FIGS. 12 and 13. In the three-dimensional image display apparatus of the working example 1, the two-dimensional image forming apparatus 30 of the light transmission type is used. On the other hand, in the three-dimensional image display apparatus of the working example 2, optical modulation means or two-dimensional image forming apparatus 30A of the reflection type is used. The optical modulation means or two-dimensional image forming apparatus 30A of the reflection type may be, for example, a liquid crystal display apparatus of the reflection type.

Referring to FIG. 12, the two-dimensional image forming apparatus 30A of the working example 2 includes a beam splitter 70 provided on the z axis, that is, on the optical axis. The beam splitter 70 has a function of passing or reflecting light depending upon the polarization of a polarized component of the light. The beam splitter 70 reflects, for example, light of an S polarized light component from within an illuminating light beam emitted from a planar light emitting member 11 toward the optical modulation means or two-dimensional image forming apparatus 30A of the reflection type, but passes light of a P polarized light component therethrough. Further, the beam splitter 70 passes modulated reflected light from the optical modulation means or two-dimensional image forming apparatus 30A therethrough. Meanwhile, in the three-dimensional image display apparatus of the working example 2 shown in FIG. 13, the beam splitter 70 passes, for example, light of a P polarized light component from within an illuminating light beam emitted from a planar light emitting member 11 to direct the light toward the optical modulation means or two-dimensional image forming apparatus 30A, but reflects light of an S polarized light component. Further, the beam splitter 70 reflects modulated reflected light from the optical modulation means or two-dimensional image forming apparatus 30A. Except those described above, the three-dimensional image display apparatus of the working example 2 may be same in configuration and structure as the three-dimensional image display apparatus of the working example 1, and therefore, overlapping detailed description of the configuration and the structure of the three-dimensional image display apparatus of the working example 2 are omitted herein to avoid redundancy.

It is to be noted that the optical modulation means or two-dimensional image forming apparatus of the reflection type may alternatively have such a different configuration that a movable mirror is provided in each aperture, that is, a two-dimensional MEMS wherein movable mirrors are arrayed in a two-dimensional matrix is used. In this instance, a two-dimensional image is produced by movement/no-movement of each movable mirror, and besides, Fraunhofer diffraction is caused by each aperture. It is to be noted that, where a two-dimensional MEMS is used, no beam splitter is necessary, but illuminating light may be introduced from an oblique direction to the two-dimensional type MEMS.

### Working Example 3

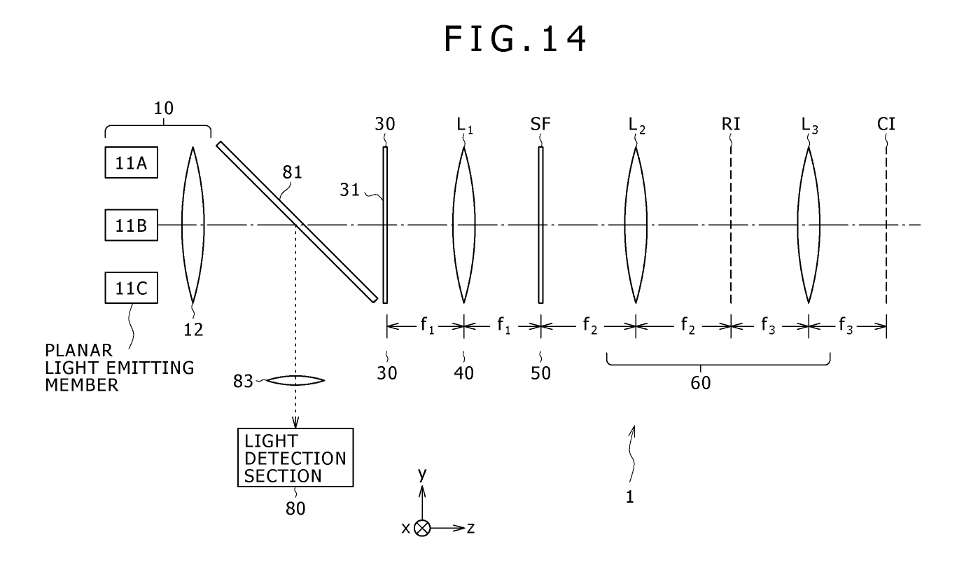

The working example 3 is another modification to the working example 1 and includes a light detection section 80 for measuring the light intensity of light beams or illuminating light beams successively emitted from the planar light emitting members 11. More particularly, in the working example 3, the light detection section 80 is formed from a photodiode. FIG. 14 shows the three-dimensional image display apparatus of the working example 3 on the yz plane. Referring to FIG. 14, the three-dimensional image display apparatus of the working example 3 includes a light detection section 80 in the form of a photodiode, and a partially reflecting mirror or partial reflector 81 disposed between the light source 10 and the two-dimensional image forming apparatus 30, more particularly between the collimator lens 12 and the two-dimensional image forming apparatus 30. The partial reflector 81 extracts part of light incoming from the planar light emitting member 11 to the two-dimensional image forming apparatus 30 and directs the extracted light to the light detection section 80 through a lens 83.

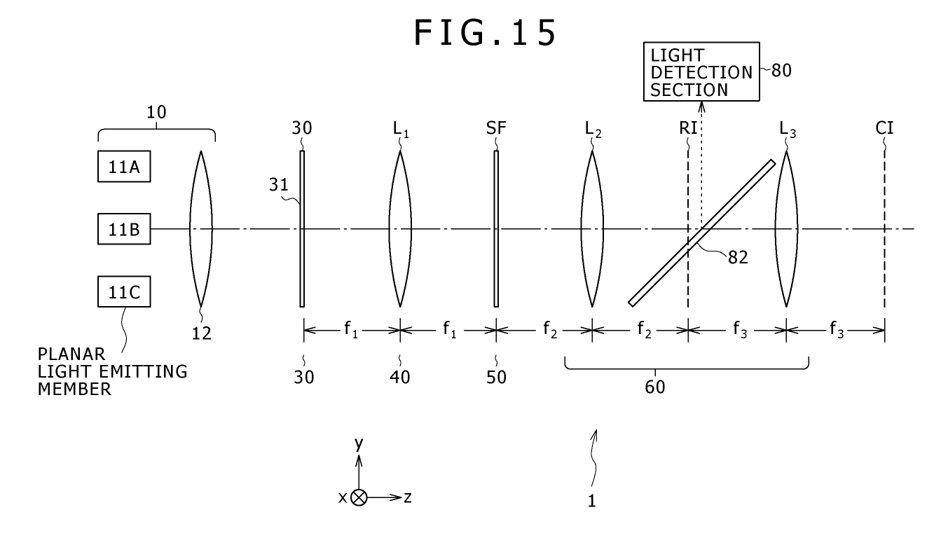

FIG. 15 shows another three-dimensional image display apparatus of the working example 3 on the yz plane. Referring to FIG. 15, the three-dimensional image display apparatus of the working example 3 includes a partially reflecting mirror 82 disposed rearwardly of the spatial filter SF or Fourier transform image selection means 50, more particularly, rearwardly of the second lens L₂. The partially reflecting mirror 82 extracts part of light emitted from the spatial filter SF or Fourier transform image selection means 50 and directs the extracted light to the light detection section 80 through a lens not shown.

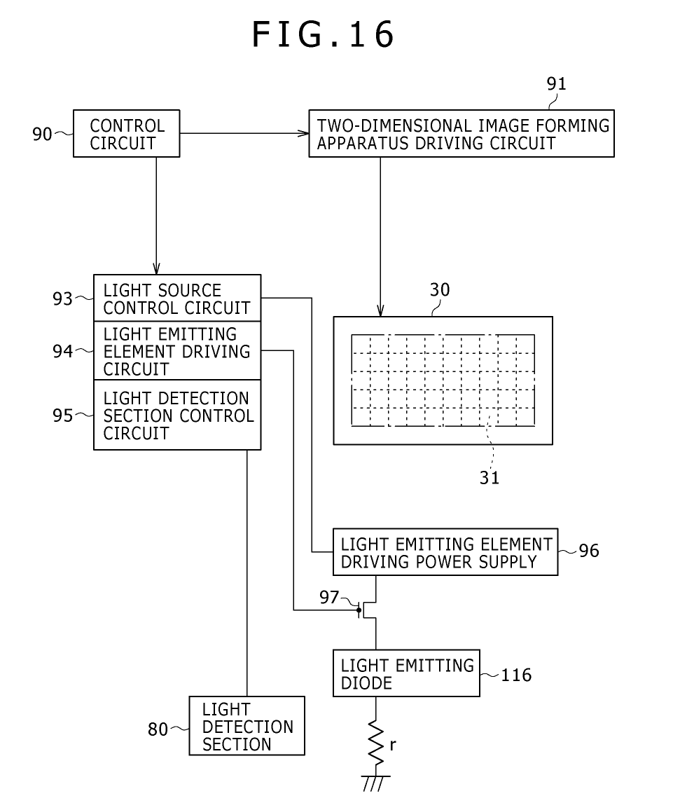

The light emitting state of the planar light emitting members 11 is controlled based on a result of measurement of the intensity of light by the light detection section. Referring to FIG. 16, operation of the two-dimensional image forming apparatus 30, planar light emitting member 11 and spatial filter SF or Fourier transform image selection means 50 is controlled by a control circuit 90. The control circuit 90 includes a light source control circuit 93 for controlling a light emitting diode 116, which forms each planar light emitting member 11, between on and off states in accordance with a pulse width modulation (PWM) controlling method, and a two-dimensional image forming apparatus driving circuit 91. The light source control circuit 93 includes a light emitting element driving circuit 94 and a light detection section control circuit 95. The control circuit 90 may be formed from a known circuit.

The light emitting state of the light emitting diode 116 of the planar light emitting member 11 is measured by the light detection section 80 formed from a photodiode, and an output of the light detection section 80 is inputted to the light detection section control circuit 95. The light detection section control circuit 95 converts the output from the light detection section 80 into data in the form of a signal representative of, for example, a luminance and a chromaticity of the light emitting diode 116 of the planar light emitting member 11. The data is sent to the light source control circuit 93 and compared with reference data. Then, the light emitting state of the light emitting diode 116 of the same planar light emitting member 11 upon subsequent light emission is controlled by the light emitting element driving circuit 94 under the control of the light source control circuit 93 based on a result of the comparison by the light source control circuit 93. In this manner, a feedback mechanism is formed. It is to be noted that the on/off control of current to flow through the light emitting diode 116 is carried out by a switching device 97 controlled by the light emitting element driving circuit 94. The switching device 97 may be formed, for example, from an FET. Further, a resistor r for current detection is inserted in series to the light emitting diode 116 on the downstream side of the light emitting diode 116 which forms the planar light emitting member 11. Thus, operation of a light emitting element driving power supply 96 is controlled by the light source control circuit 93 so that the voltage drop by the resistor r may exhibit a predetermined value.

Or, the operation state of the two-dimensional image forming apparatus 30 is controlled based on a result of measurement of the light intensity by the light detection section. In particular, the light emitting state of the light emitting diode 116 which forms the planar light emitting member 11 is measured by the light detection section 80 formed from a photodiode, and an output of the light detection section 80 is inputted to the light detection section control circuit 95. The light detection section control circuit 95 converts the received output of the light detection section 80 into data or a signal, for example, of a luminance and a chromaticity of the light emitting diode 116 of the planar light emitting member 11, and the data is sent to the light source control circuit 93 and compared with reference data. Then, a result of the comparison is sent to the two-dimensional image forming apparatus driving circuit 91. Then, the numerical aperture or light transmission factor of the aperture of the pixel 31 upon subsequently light emission of the same planar light emitting member 11 is controlled based on the received result of the comparison by the light source control circuit 93. In this manner, a feedback system is formed. It is to be noted that control of the light emitting state of the planar light emitting member 11 and control of the operation state of the two-dimensional image forming apparatus 30 may be carried out jointly. Further, the operation state of the spatial filter SF or Fourier transform image selection means 50 is controlled based on the result of measurement of the light intensity by the light detection section 80. Correction of the luminance can be carried out by controlling the numerical aperture or light transmission factor of the aperture 51 of the spatial filter SF or Fourier transform image selection means 50.

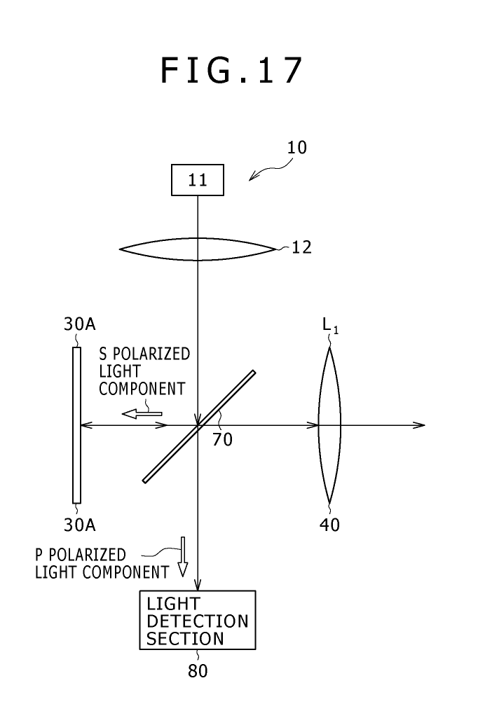

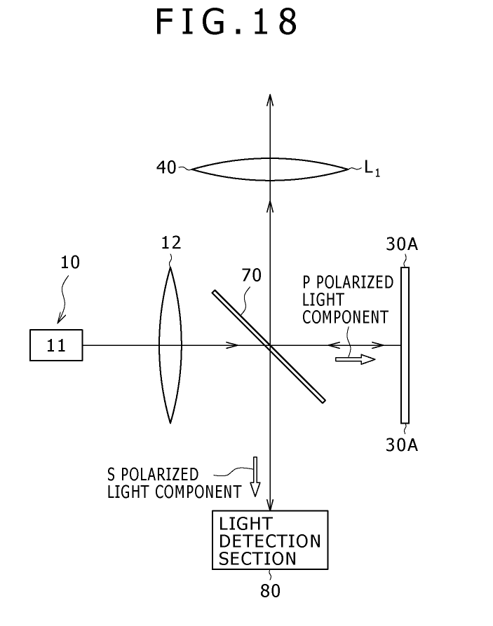

Examples wherein the light detection section 80 is incorporated in the three-dimensional image display apparatus according to the working example 2 described hereinabove with reference to FIGS. 12 and 13, that is, three-dimensional image display apparatus wherein the beam splitter 70 is disposed between the light source 10 and the two-dimensional image forming apparatus 30 such that part of light to be introduced from each planar light emitting member 11 to the two-dimensional image forming apparatus 30 is extracted and introduced into the light detection section 80 through a lens (not shown) are shown in FIGS. 17 and 18.

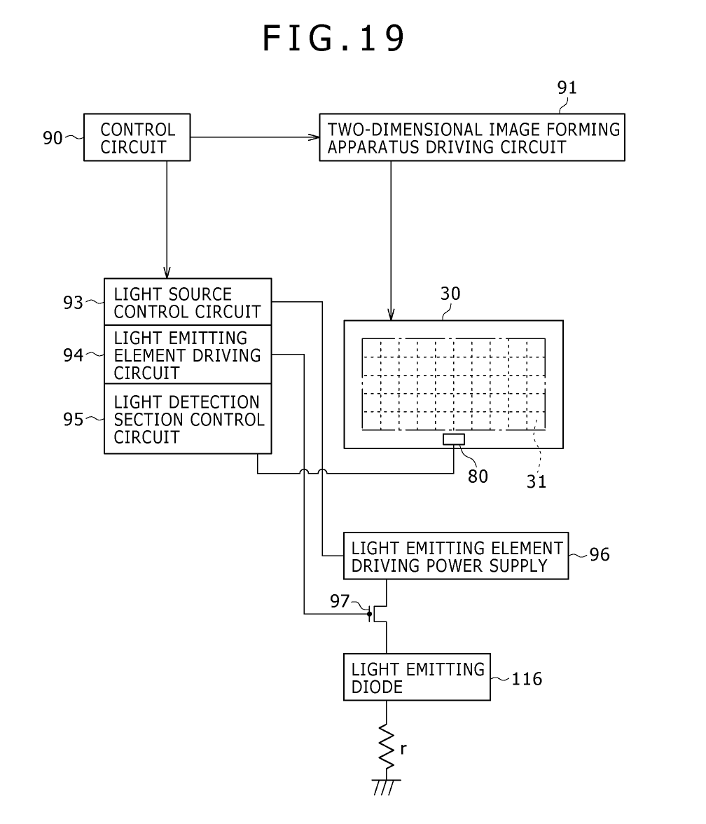

Further, an example wherein the light detection section 80 is attached to the two-dimensional image forming apparatus 30 is shown in FIG. 19. It is to be noted that the light detection section 80 may be disposed in the proximity of each of the planar light emitting members 11 shown in FIG. 6. Or, the light detection section 80 may be incorporated in each planar light emitting member 11 or may otherwise be disposed at a position at which it does not intercept light to be introduced from the light source 10 to the two-dimensional image forming apparatus 30.

### Working Example 4

The working example 4 and working examples 5 to 7 which are hereinafter described are modifications to the working examples 1 to 3 and particularly include a modified planar light emitting member.

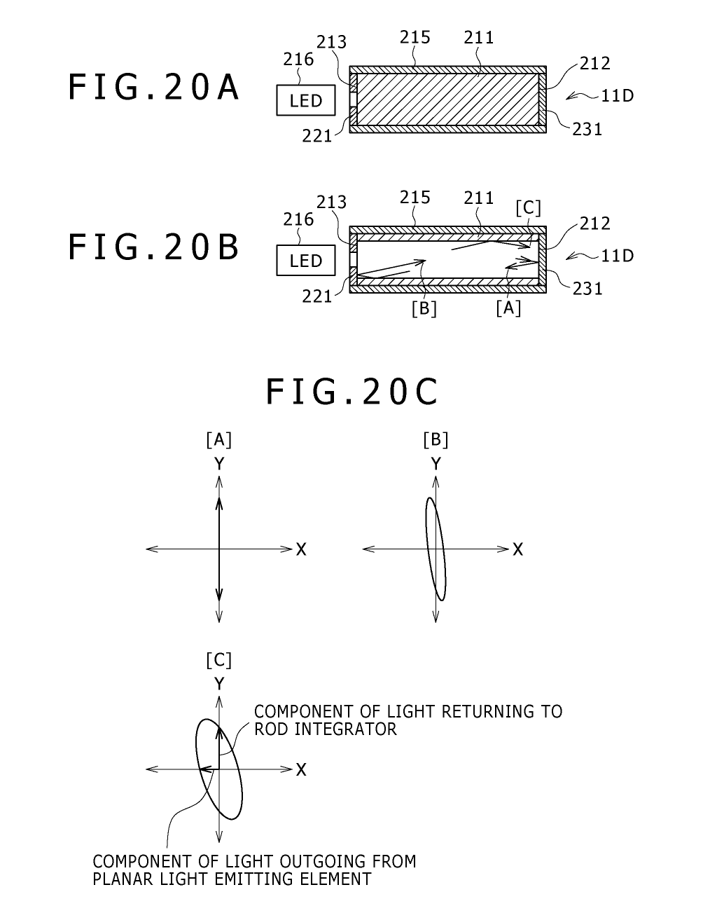

In the working example 4, as seen from a schematic sectional view of FIG. 20A or 20B, each planar light emitting member 11D includes:

(a) a rod integrator 211 for emitting light from a first end face 212 thereof;

(b) a light emitting diode 216 disposed adjacent a second end face 213 of the rod integrator 211;

(c) a reflection type polarizing member 231 disposed adjacent the first end face 212 of the rod integrator 211 for passing part of light incoming thereto in response to a polarization state of the light while reflecting the remaining part of the light; and

(d) a light reflecting member 221 provided at a portion of the second end face 213 of the rod integrator 211 at which the light reflecting member 221 does not intercept light emitted from the light emitting diode 216.

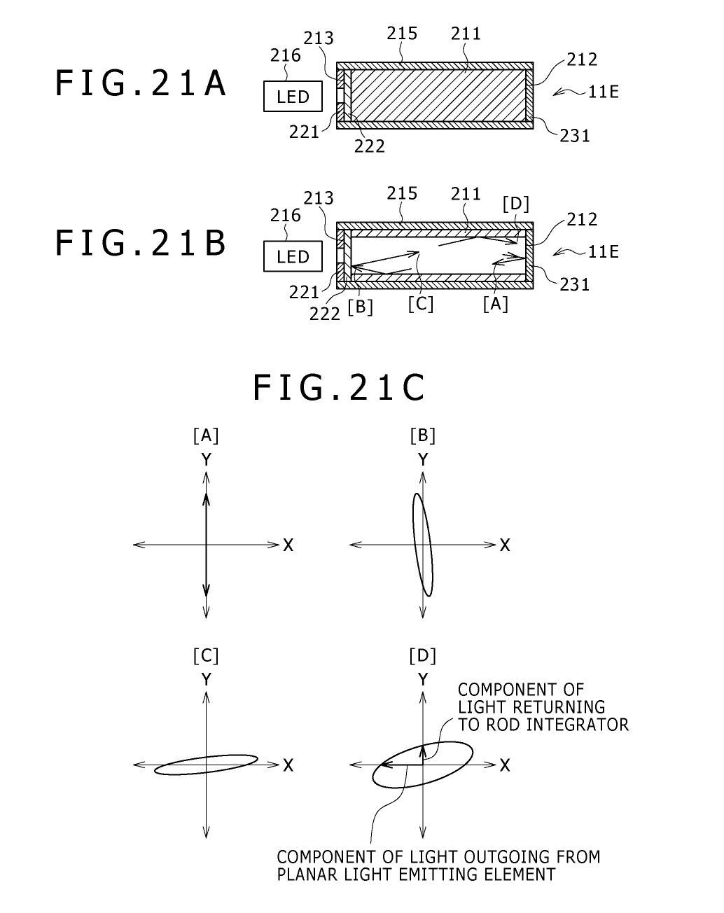

Here, since the rod integrator 211 or the light emitting diode 216 may be formed similarly in configuration and structure to the rod integrator 111 or the light emitting diode 116 in the working example 1, overlapping detailed description of them is omitted herein to avoid redundancy. It is to be noted that, in the example of FIG. 20A or in an example of FIG. 21A hereinafter described, the rod integrator 211 is formed from a solid member while, in the example of FIG. 20B or in an example shown in FIG. 21B hereinafter described, the rod integrator 211 is formed from a hollow member. Further, a light reflecting layer 215 is formed from an aluminum layer produced by vacuum vapor deposition on an outer face of a hollow member or a solid member.

The reflection type polarizing member 231 is structured such that, for example, ribs of aluminum are formed with a width of several tens nm in a pitch of one hundred and several tens nm on the surface of a substrate made of a transparent material, or has a laminated layer structure including a plurality of layers of different refraction factors laminated one on another. The reflection type polarizing member 231 can be disposed adjacent the first end face 212 of the rod integrator 211 by adhering the substrate to the first end face 212 or by forming the laminated layer structure directly on the first end face 212. The light reflecting member 221 can be obtained by vacuum vapor deposition of an aluminum layer on a substrate made of a resin material or the like. Further, the rod integrator 211 can be disposed adjacent the second end face 213 of the rod integrator 211 by adhering the substrate thereof.

In the planar light emitting member 11D in the working example 4, light emitted from the light emitting diode 216 and having a random polarization state is introduced into the rod integrator 211. Then, the light propagates in the rod integrator 211 until it comes to the reflection type polarizing member 231. Then, a P polarized light component from within the light coming to the reflection type polarizing member 231 passes through the reflection type polarizing member 231 and goes out from the rod integrator 211. On the other hand, an S polarized light component is reflected by the reflection type polarizing member 231 and propagates in the rod integrator 211 until it comes to and is reflected by the light reflecting member 221. Then, the light further propagates in the rod integrator 211 and comes to the reflection type polarizing member 231 again. The light at this time includes some P polarized light component produced by the reflection in the rod integrator 211. The thus produced P polarized light component passes through the reflection type polarizing member 231 and goes out from the rod integrator 211.

The polarization state of such light which propagates in the rod integrator 211 is schematically illustrated in FIG. 20C. Referring to FIG. 20C, light indicated by a state “A” is the light emitted from the light emitting diode 216 and coming to and reflected by the reflection type polarizing member 231. Meanwhile, light indicated by another state “B” is the light reflected by the reflection type polarizing member 231, propagating in the rod integrator 211 and reflected by the light reflecting member 221. Further, light indicated by a further state “C” is the light immediately before it comes to the reflection type polarizing member 231 after it is reflected by the light reflecting member 221 and propagates in the rod integrator 211. It is to be noted that, in FIG. 20C or in FIG. 21C hereinafter described, the X axis indicates the P polarized light component of light, and the Y axis indicates the S polarized light component.

Then, such states as described above repetitively appear during light emission of the light emitting diode 216. Therefore, light emitted from the light emitting diode 216 goes out efficiently from the rod integrator 211.

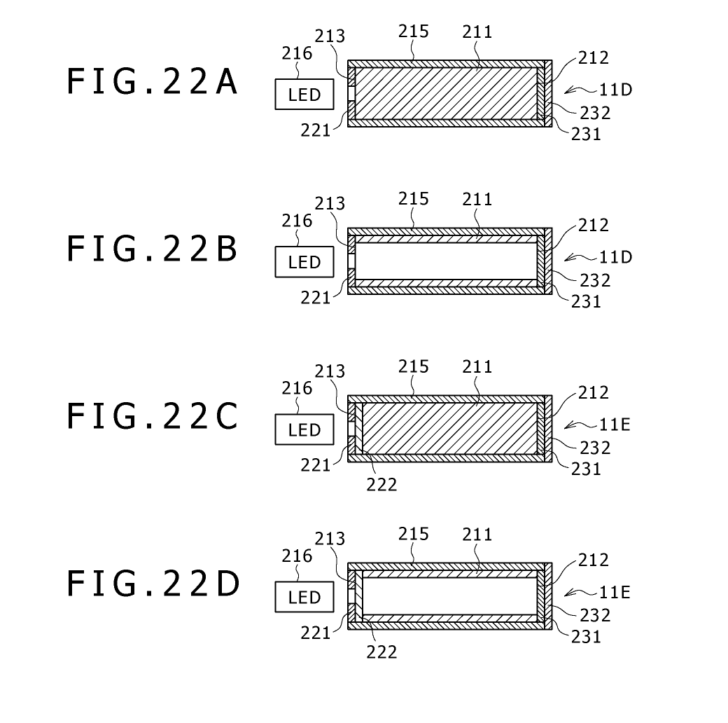

It is to be noted that a light diffusing member 232 formed from a PET film may be adhered to the reflection type polarizing member 231 as seen in FIG. 22A or 22B. Or, a light diffusing layer may be provided between the light reflecting member 221 and the second end face 213 of the rod integrator 211 similarly to the light diffusing layer 114 in the working example 1.

### Working Example 5

The working example 5 is a modification to the working example 4. In each of the planar light emitting members 11E in the working example 5, a quarter-wave plate 222 is disposed between the second end face 213 of the rod integrator 211 and the light reflecting member 221 as schematically shown in FIGS. 21A and 21B.

In the planar light emitting member 11E in the working example 5, light emitted from the light emitting diode 216 and having a random polarization state enters the rod integrator 211. Then, a P polarized light component from within the light incoming to the reflection type polarizing member 231 passes through the reflection type polarizing member 231 and goes out from the rod integrator 211. On the other hand, an S polarized light component is reflected by the reflection type polarizing member 231 and propagates in the rod integrator 211 and then passes through the quarter-wave plate 222. Thereafter, the S polarized light component comes to and is reflected by the light reflecting member 221 and then passes through the quarter-wave plate 222 again, whereafter it propagates in the rod integrator 211 and comes to the reflection type polarizing member 231 again. At this time, the light includes some P polarized light component by the passage in the quarter-wave plate 222 and the reflection in the rod integrator 211. The P polarized light component produced in this manner passes through the reflection type polarizing member 231 and goes out from the rod integrator 211.

The polarization state of light which propagates in the rod integrator 211 in this state is schematically illustrated in FIG. 21C. Referring to FIG. 21C, light indicated by a state “A” is the light emitted from the light emitting diode 216 and coming to and reflected by the reflection type polarizing member 231. Meanwhile, light indicated by another state “B” is the light reflected by the reflection type polarizing member 231, propagating in the rod integrator 211 and entering the quarter-wave plate 222. Further, light indicated by a further state “C” is the light entering the quarter-wave plate 222, reflected by the light reflecting member 221 and going out from the quarter-wave plate 222. Still further, light indicated by a further state “D” is the light immediately before it comes to the reflection type polarizing member 231 after it goes out from the quarter-wave plate 222 and propagates in the rod integrator 211. The polarization state of the light entering the quarter-wave plate 222, reflected by the light reflecting member 221 and going out from the quarter-wave plate 222 is different from that of the light immediately before it enters the quarter-wave plate 222.

Then, such states as described above repetitively appear during light emission of the light emitting diode 216. Therefore, light going out from the light emitting diode 216 is emitted more efficiently from the rod integrator 211 than in the working example 4. It is to be noted that a light diffusing member 232 may be provided on the reflection type polarizing member 231 as seen in FIG. 22C or 22D similarly as in the working example 4. Or, a light diffusing layer may be provided between the light reflecting member 221 and the quarter-wave plate 222 similarly to the light diffusing layer 114 in the working example 1. Or else, a light diffusing layer may be provided between the quarter-wave plate 222 and the second end face 213 of the rod integrator 211 similarly to the light diffusing layer 114 in the working example 1. It is to be noted that a gap may exist between the second end face 213 of the rod integrator 211 and the quarter-wave plate 222 or a gap may exist between the quarter-wave plate 222 and the light reflecting member 221. Further, a gap may exist between the reflection type polarizing member 231 and the light diffusing member 232.

### Working Example 6

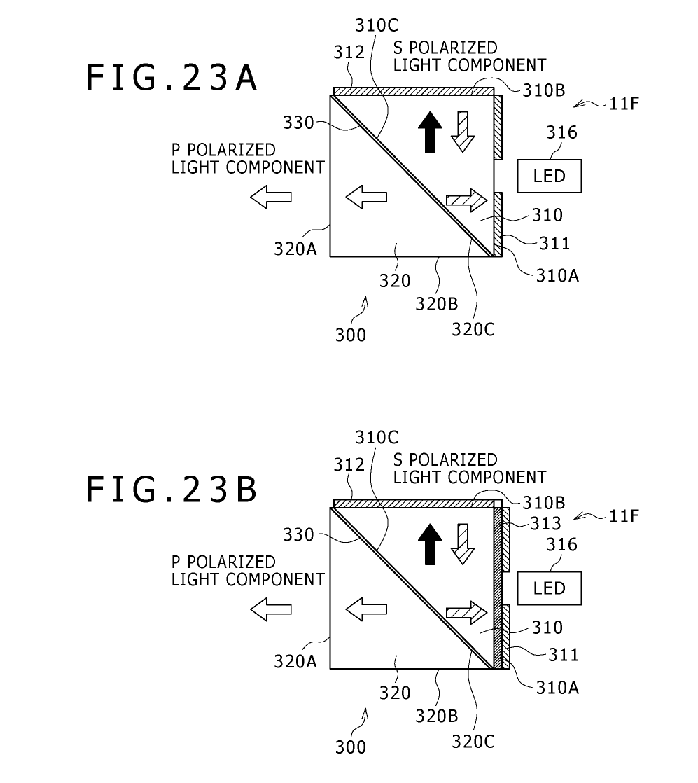

In the working example 6, as schematically shown in a sectional view of FIG. 23A, each planar light emitting member 11F includes:

(a) a P and S polarized light separation conversion element 300 including a first prism 310, a second prism 320 and a polarizing beam splitter 330; and

(b) a light emitting diode 316.

It is to be noted that the light emitting diode 316 may be formed similarly in configuration and structure to the light emitting diode 116 in the working example 1, and therefore, overlapping detailed description of the same is omitted herein to avoid redundancy.

The first prism 310 and the second prism 320 both made of optical glass are disposed in an opposing relationship to each other across a polarized light separating face of the polarizing beam splitter 330. The first prism 310 includes a first light reflecting member 311 and a second light reflecting member 312 provided at portions thereof at which they do not intercept light emitted from the light emitting diode 316. An S polarized light component of light emitted from the light emitting diode 316 and coming into the first prism 310 is reflected by the polarizing beam splitter 330 as indicated by a solid arrow mark in FIG. 23A and then reflected by the second light reflecting member 312 as indicated by an arrow mark with slanting lines in FIG. 23A. Thereafter, the S polarized light component is reflected by the polarizing beam splitter 330 again as indicated by another arrow mark with slanting lines in FIG. 23A and further reflected by the first light reflecting member 311. Meanwhile, a P polarized light component of the light emitted from the light emitting diode 316 and coming into the first prism 310 and a P polarized light component of light reflected by the first light reflecting member 311 pass through the polarizing beam splitter 330 as indicated by a blank arrow mark in FIG. 23A and goes out from an emitting face 320A of the second prism 320.

The first prism 310 is formed, for example, from a triangular prism having a first inclined face 310A, a second inclined face 310B and a bottom face 310C. Also the second prism 320 is formed from a triangular prism having the first inclined face 320A, a second inclined face 320B and a bottom face 320C. It is to be noted that the bottom face 310C of the first prism 310 and the bottom face 320C of the second prism 320 are disposed in an opposing relationship to each other across a polarized light separation face of the polarizing beam splitter 330. The first light reflecting member 311 is disposed on the first inclined face 310A of the first prism 310. The second light reflecting member 312 is disposed on the second inclined face 310B of the first prism 310. An S polarized light component of light incoming through the first inclined face 310A of the first prism 310 is reflected toward the second inclined face 310B of the first prism 310 by the polarizing beam splitter 330. Meanwhile, a P polarized light component passes through the polarizing beam splitter 330 and goes out efficiently from the first inclined face 320A of the second prism 320.

It is to be noted that a quarter-wave plate 313 may be disposed between the first inclined face 310A of the first prism 310 and the first light reflecting member 311 as seen in FIG. 23B. Or, as occasion demands, the second prism 320 may be omitted. It is to be noted that, in the working example 6, a gap may exist between the first prism 310 and the light reflecting member 311 or 312. Or, a gap may exist between the first light reflecting member 311 and the quarter-wave plate 313, or a gap may exist between the first prism 310 and the quarter-wave plate 313.

### Working Example 7

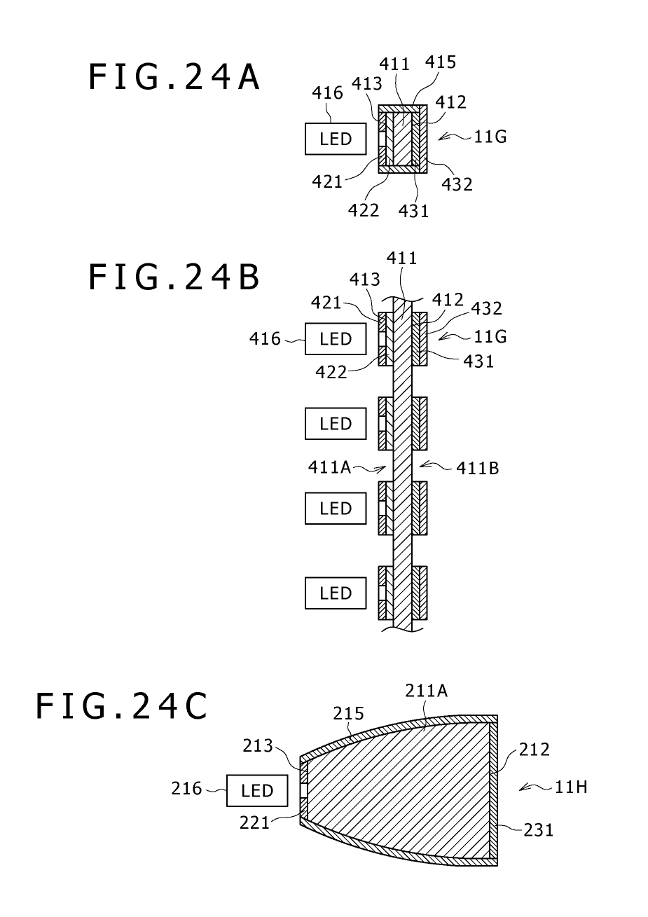

In the working example 7, as schematically shown in FIG. 24A, each planar light emitting member 11G includes:

(a) a plate-formed member 411 formed from an optical glass plate for emitting light from a first end face 412 thereof;

(b) a light emitting diode 416 disposed adjacent a second end face 413 of the plate-formed member 411;

(c) a reflection type polarizing member 431 disposed adjacent the first end face 412 of the plate-formed member 411 for passing part of incoming light therethrough in response to a polarization state of the light while reflecting the remaining part of the incoming light;

(d) a light reflecting member 421 provided at a portion of the second end face 413 of the plate-formed member 411 at which the light reflecting member 421 does not intercept the light emitted from the light emitting diode 416;

(e) a quarter-wave plate 422 disposed between the second end face 413 of the plate-formed member 411 and the light reflecting member 421; and

(f) a light diffusing member 432 provided on the reflection type polarizing member 431.

Such components of the planar light emitting member 11G as the light emitting diode 416, reflection type polarizing member 431, light reflecting member 421, quarter-wave plate 422, light diffusing member 432 and light reflecting layer 415 may be same as the components of the planar light emitting member 11D of the working example 4 described hereinabove. Therefore, overlapping detailed description of them is omitted herein to avoid redundancy. The behavior of light emitted from the light emitting diode 416 and incoming to the plate-formed member 411 is substantially same as the behavior of light in the planar light emitting member 11E in the working example 5 described hereinabove with reference to FIG. 21C. It is to be noted that a light diffusing layer may be provided between the light reflecting member 421 and the quarter-wave plate 422 similarly to the light diffusing layer 114 in the working example 1, or a light diffusing layer may be provided between the quarter-wave plate 422 and the second end face 413 similarly to the light diffusing layer 114 in the working example 1. It is to be noted that a gap may exist between the second end face 413 of the plate-formed member 411 and the quarter-wave plate 422, or a gap may exist between the quarter-wave plate 422 and the light reflecting member 421. Further, a gap may exist between the reflection type polarizing member 431 and the light diffusing member 432.

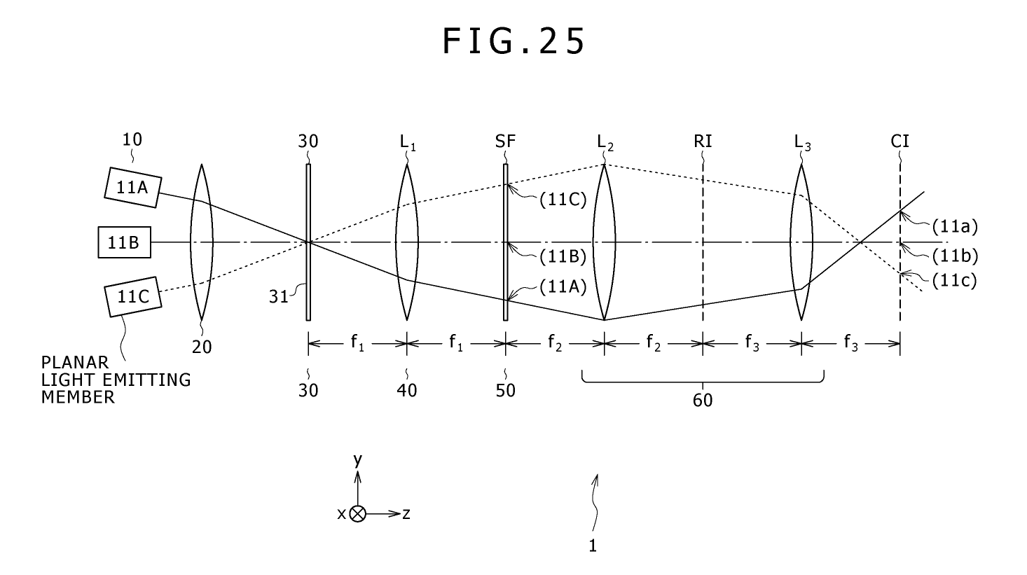

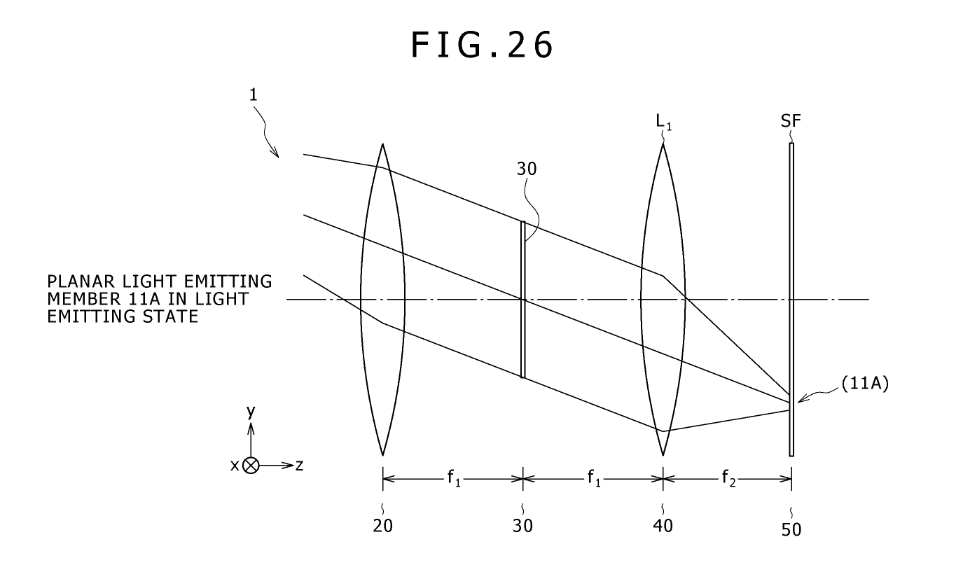

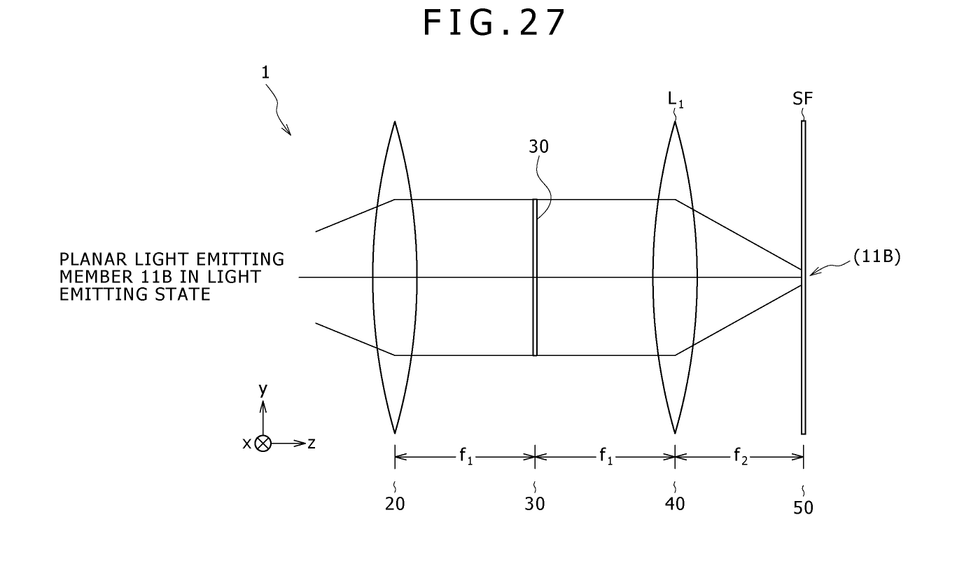

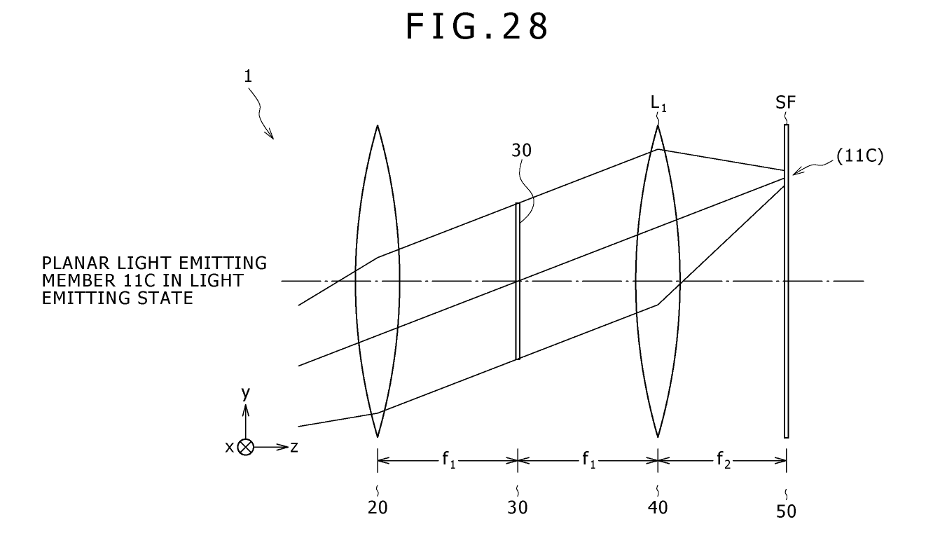

While the three-dimensional image display apparatus of the present invention is described above in connection with the preferred working examples thereof, the present invention is not limited to the specific working examples. While, in the working examples, the collimator lens 12 is disposed between the light source 10 and the optical modulation means or two-dimensional image forming apparatus 30 or 30A, a microlens array composed of microlenses arrayed in a two-dimensional matrix may be used in place of the collimator lens 12.

Where the light source 10 includes a plurality of planar light emitting members 11 arrayed in a two-dimensional matrix, the planar light emitting members 11 may be arranged such that the outgoing directions of light beams emitted from the planar light emitting members 11 are different from each other. By the arrangement just described, the optical modulation means or two-dimensional image forming apparatus can be illuminated with illuminating light beams successively emitted from different light emitting positions of the light source and having different incoming directions. A schematic view of a three-dimensional image display apparatus where the three-dimensional image display apparatus of the working example 1 adopts a light source of such a configuration as just described is shown in FIG. 25. It is to be noted that, in FIG. 25, one of light fluxes emitted from a planar light emitting member 11A which composes the light source 10 is indicated by a solid line and one of light fluxes emitted from another planar light emitting member 11B is indicated by an alternate long and short dash line while one of light fluxes emitted from a further planar light emitting member 11C is indicated by a broken line. Further, the positions of images on the spatial filter SF formed from illuminating light beams emitted from the planar light emitting members 11A, 11B and 11C are denoted by 11A, 11B and 11C, respectively, the positions of images on the rear side focal plane of the third lens L₃ formed from the illuminating light beams emitted from the planar light emitting members 11A, 11B and 11C are denoted by 11a, 11b and 11c, respectively. Further, associated elements of the optical modulation means or two-dimensional image forming apparatus 30, Fourier transform image forming means 40 or first lens L₁ and Fourier transform image selection means 50 or spatial filter SF are schematically shown in an enlarged scale in FIGS. 26, 27 and 28. Further, FIGS. 26, 27 and 28 illustrate the states wherein light fluxes emitted from the planar light emitting members 11A, 11B and 11C of the light source 10 individually pass through the two-dimensional image forming apparatus 30, first lens L₁ and spatial filter SF. It is to be noted that the position numbers of the planar light emitting members 11A, 11B and 11C of the light source 10 are, for example, (5, 0), (0, 0) and (−5, 0), respectively. Here, when a certain one of the planar light emitting members 11 is in a light emitting state, all of the other planar light emitting members 11 are in a no-light emitting state. It is to be noted that, in FIG. 25, reference numeral 20 denotes an illuminating optical system formed from a lens for shaping an illuminating light beam.

Further, the spatial filter SF or Fourier transform image selection means 50 may be replaced by a scattering diffraction limiting member having U₀×V₀ apertures and positioned on the rear side focal plane of the first lens L₁. This scattering diffraction limiting member can be produced by forming apertures such as, for example, pinholes in a plate-like member which does not pass light therethrough. Here, the positions of the apertures may be set to positions at which desired ones of Fourier transform images or diffracted light beams, that is, Fourier transform images or diffracted light beams having, for example, the 0th diffraction order, obtained by the Fourier transform image selection means 50 or first lens L₁, are formed. Such positions of the apertures may be provided corresponding to a plurality of planar light emitting members 11.

In the working example 1 and the working example 2, the optical modulation means or two-dimensional image forming apparatus 30 or 30A or the diffracted light production section is disposed on the front side focal plane of the lens which forms the Fourier transform image forming means 40, that is, the first lens L₁, and the Fourier transform image selection means is disposed on the rear side focal plane of the lens. However, as occasion demands, although a stereoscopic image obtained finally is somewhat deteriorated, the optical modulation means or two-dimensional image forming apparatus 30 or 30A or the diffracted light production section may be disposed at a position displaced from the front side focal plane of the lens which forms the Fourier transform image forming means 40, that is, the first lens L₁, and the spatial filter SF or Fourier transform image selection means 50 may be disposed at a position displaced from the rear side focal plane of the first lens L₁. Further, each of the first lens L₁, second lens L₂ and third lens L₃ is not limited to a convex lens but may be suitably formed from an appropriate lens.

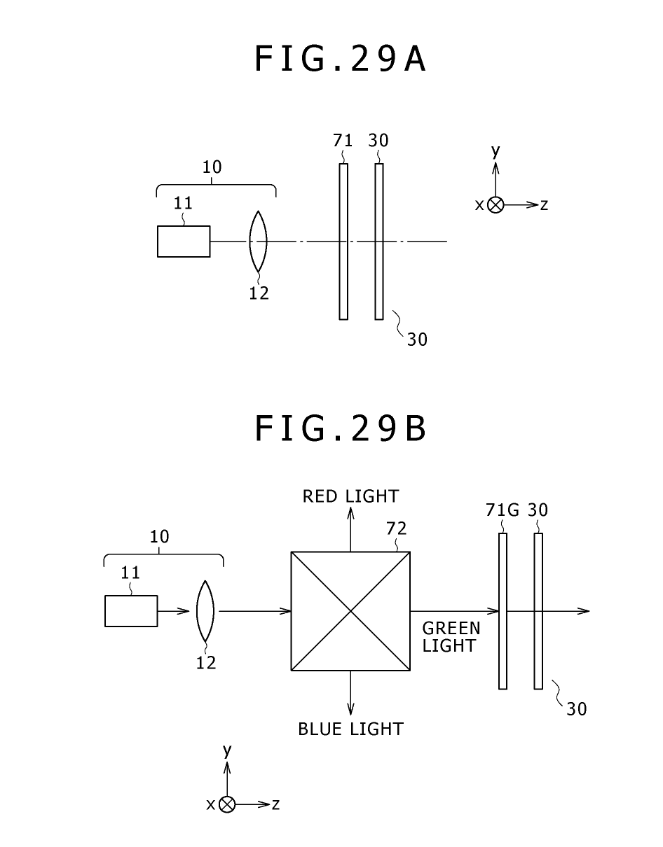

In the working example 1 and the working example 2, the light source is presumed as a light source for light of a single color or for light of a color proximate to a single color. However, the configuration of the light source is not limited to this. In particular, the light source 10 may emit light in a plurality of wavelength regions. However, in this instance, for example, if the three-dimensional image display apparatus of the working example 1 is taken as an example, preferably a narrow band filter 71 for selecting a wavelength is disposed between the collimator lens 12 and the optical modulation means or two-dimensional image forming apparatus 30 as seen in FIG. 29A. This makes it possible to separate and select a wavelength band and extract monochromatic light.

Or, the wavelength band of the light source 10 may extend over a wide wavelength band. However, in this instance, preferably a dichroic prism 72 and a narrow band filter 71G for selecting a wavelength are disposed between the collimator lens 12 and the optical modulation means or two-dimensional image forming apparatus 30 as seen in FIG. 29B. In particular, the dichroic prism 72 reflects, for example, red light and blue light in different directions but passes a beam of light including green light therethrough. The narrow band filter 71G for separating and selecting green light is disposed on the side of the dichroic prism 72 from which a light beam goes out.

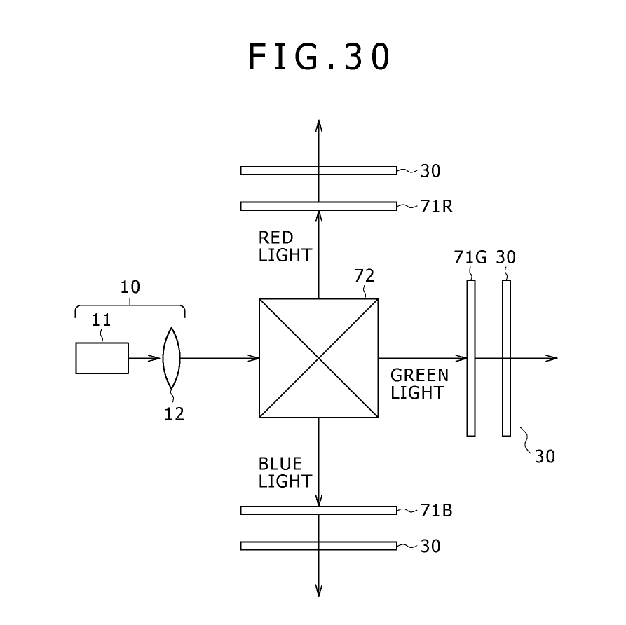

Further, if, as shown in FIG. 30, a narrow band filter 71G for separating and selecting green light is disposed on the outgoing side of the dichroic prism 72 from which a light beam including green light goes out and a narrow band filter 71R for separating and selecting red light is disposed on the outgoing side of the dichroic prism 72 from which a light beam including red light goes out while a narrow band filter 71B for separating and selecting blue light is disposed on the outgoing side of the dichroic prism 72 from which a light beam including blue light goes out, then a light source for three three-dimensional image display apparatuses which display three primary colors respectively can be configured. If three three-dimensional image display apparatus having such a configuration as just described are used or a combination of a light source for emitting red light and a three-dimensional image display apparatus, a light source for emitting green light and another three-dimensional image display apparatus, and a light source for emitting blue light and a further three-dimensional image display apparatus is used such that images from the three three-dimensional image display apparatuses are combined, for example, using a combining prism, then color display can be achieved. It is to be noted that a dichroic mirror may be used in place of the dichroic prism. Or, if a light source is formed from a red planar light emitting member, a green planar light emitting member and a blue planar light emitting member and the red planar light emitting member, green planar light emitting member and blue planar light emitting member are successively placed into a light emitting state, then color display can be obtained. It is to be noted that such modifications to the three-dimensional image display apparatus as described above may naturally be applied to the working example 2.

Further, the various modifications to the three-dimensional image display apparatus described hereinabove may include the light detection section described hereinabove in connection with the working example 3. Further, luminance compensation or correction or temperature control of a light emitting diode which composes the planar light emitting members may be carried out by supervising the temperature of the light emitting diode by means of a temperature sensor and feeding back a result of the supervision to the light source control circuit 93. More particularly, for example, a Pertier device may be attached to a light emitting diode which composes the planar light emitting members so that temperature control of the light emitting diode can be carried out.

Further, in the planar light emitting member 11G described hereinabove in connection with the working example 7, the plate-formed member 411 may be formed commonly to a plurality of planar light emitting members 11G as seen in FIG. 24B. It is to be noted that, in this instance, a light absorbing layer may be provided on exposed faces 411A and 411B of the plate-formed member 411. Further, in order to control the polarization state of light to be emitted from the planar light emitting members 11D, 11E, 11F and 11G described hereinabove in connection with the working examples 4 to 7, a quarter-wave plate for passing light emitted from each planar light emitting member therethrough may be disposed, for example, between the planar light emitting member and the optical modulation means or two-dimensional image forming apparatus 30. Further, the planar light emitting members 11D, 11E, 11F and 11G described in connection with the working examples 4 to 7 may be used not only as the planar light emitting members in the three-dimensional image display apparatus of the present invention but also as other light sources. In particular, it is possible to use the planar light emitting members, for example, as a light source for a planar light source apparatus or backlight for a liquid crystal display apparatus of the transmission type or the reflection type or as a light source for a liquid crystal display apparatus of the direct-view type or the projection type for color display. Further, it is possible to use a discharge lamp or a fluorescent lamp as the light source. It is to be noted that, where the planar light emitting members are used as other light sources, one light emitting element may be disposed on one planar light emitting element or two or more light emitting elements may be disposed on one planar light emitting element. Further, it is possible to use, for example, a transparent member 211A having a tapering sectional shape in a planar light emitting member 11H as seen in FIG. 24C in place of the rod integrator shown in FIG. 20A. It is to be noted that the transparent member 211A having such a tapering sectional shape can be applied also where the other planar light emitting members in the working examples 4 to 7 are used as other light sources.

While preferred embodiments of the present invention have been described using specific terms, such description is for illustrative purposes only, and it is to be understood that changes and variations may be made without departing from the spirit or scope of the following claims.

What is claimed is:

1. A three-dimensional image display apparatus, comprising:
(A) a light source including U₀×V₀ planar light emitting members disposed in a two-dimensional matrix;
(B) optical modulation means having a plurality of pixels for modulating light beams successively outputted from said planar light emitting members by means of each of said pixels to produce a two-dimensional image and emitting spatial frequencies of the produced two-dimensional image along a plurality of diffraction angles corresponding to different diffraction orders produced from said pixels; and
(C) Fourier transform image forming means for Fourier transforming the spatial frequencies of the two-dimensional image emitted from said optical modulation means to produce a number of Fourier transform images corresponding to the number of diffraction orders and forming the Fourier transform images.

2. The three-dimensional display apparatus according to claim 1, further comprising
(D) conjugate image forming means for forming conjugate images of the Fourier transform images formed by said Fourier transform image forming means.

3. The three-dimensional display apparatus according to claim 1, further comprising
(E) Fourier transform image selection means for selecting a Fourier transform image corresponding to a desired diffraction order from among the number of produced Fourier transform images corresponding to the number of diffraction orders,
wherein said Fourier transform image selection means is disposed at a position at which the Fourier transform images are formed.

4. The three-dimensional image display apparatus according to claim 3, wherein said Fourier transform image selection means is formed from a liquid crystal display apparatus.

5. The three-dimensional image display apparatus according to claim 3, wherein said Fourier transform image selection means has U₀×V₀ apertures.

6. The three-dimensional image display apparatus according to claim 5, wherein said apertures of said Fourier transform image selection means have a size substantially equal to that of the Fourier transform images formed on said Fourier transform image selection means.

7. The three-dimensional image display apparatus according to claim 1, further comprising
inverse Fourier transform means for inverse Fourier transforming the Fourier transform images formed by said Fourier transform image forming means to form a real image of the two-dimensional images produced by said optical modulation means.

8. The three-dimensional image display apparatus according to claim 1, wherein said optical modulation means is formed from a two-dimensional spatial optical modulator having a plurality of pixels arrayed two-dimensionally, and each of said pixels has an aperture.

9. The three-dimensional image display apparatus according to claim 1, wherein each of said planar light emitting members includes:
(a) a rod integrator configured to emit light from a first end face thereof; and
(b) a light emitting diode disposed adjacent a second end face of said rod integrator.

10. The three-dimensional image display apparatus according to claim 1, wherein each of said planar light emitting members includes:
(a) a rod integrator configured to emit light from a first end face thereof;
(b) a light emitting diode disposed adjacent a second end face of said rod integrator;
(c) a reflection type polarizing member disposed adjacent the first end face of said rod integrator and passing part of light incoming thereto in response to a polarization state of the light while reflecting the remaining part of the light; and
(d) a light reflecting member provided at a portion of the second end face of said rod integrator at which said light reflecting member does not intercept light emitted from said light emitting diode.

11. The three-dimensional image display apparatus according to claim 10, wherein each of said planar light emitting members further includes
(e) a quarter-wave plate disposed between the second end face of said rod integrator and said light reflecting member.

12. The three-dimensional image display apparatus according to claim 10, wherein each of said planar light emitting members further includes
(f) a light diffusing member provided on said reflection type polarizing member.

13. The three-dimensional image display apparatus according to claim 1, wherein
each of said planar light emitting members includes
(a) a P and S polarized light separation conversion element including a first prism, a second prism and a polarizing beam splitter, and
(b) a light emitting diode;
said first and second prisms are disposed in an opposing relationship across a polarized light separation face of said polarizing beam splitter;
said first prism has first and second light reflecting members provided at portions thereof at which said first and second light reflecting members do not intercept light emitted from said light emitting diode;
an S polarized light component of light emitted from said light emitting diode and incoming to said first prism is reflected by said polarizing beam splitter, reflected by said second light reflecting member, reflected by said polarizing beam splitter again and then reflected by said first light reflecting member;
a P polarized light component of the light emitted from said light emitting diode and incoming to said first prism and a P polarized light component of the light reflected by said first light reflecting member pass through said polarizing beam splitter thereby to go out from an outgoing face of said second prism.

14. The three-dimensional image display apparatus according to claim 13, wherein each of said planar light emitting members further includes
(c) a quarter-wave plate disposed between said first prism and said first light reflecting member.

15. The three-dimensional image display apparatus according to claim 1, wherein each of said planar light emitting members includes:
(a) a plate-formed member configured to emit light from a first end face thereof;
(b) a light emitting diode disposed adjacent a second end face of said plate-formed member;
(c) a reflection type polarizing member disposed adjacent the first end face of said plate-formed member and configured to pass part of incoming light therethrough in response to a polarization state of the light while reflecting the remaining part of the incoming light;
(d) a light reflecting member provided at a portion of the second end face of said plate-formed member at which said light reflecting member does not intercept the light emitted from said light emitting diode;
(e) a quarter-wave plate disposed between the second end face of said plate-formed member and said light reflecting member; and
(f) a light diffusing member provided on said reflection type polarizing member.

16. The three-dimensional image display apparatus according to claim 1, further comprising
light detection means for measuring the light intensity of the light beams successively emitted from said planar light emitting members.

17. The three-dimensional image display apparatus according to claim 16, wherein the light emitting state of said planar light emitting members is controlled based on a result of the measurement of the light intensity by said light detection means.

18. The three-dimensional image display apparatus according to claim 16, wherein the operation state of said optical modulation means is controlled based on a result of the measurement of the light intensity by said light detection means.

19. A three-dimensional image display apparatus, comprising:
(A) a light source including U₀×V₀ planar light emitting members disposed in a two-dimensional matrix;
(B) a two-dimensional image forming apparatus having a plurality of apertures arrayed in a two-dimensional matrix in X and Y directions and configured to control passage or reflection of each of light beams successively emitted from said planar light emitting members individually for said apertures to produce a two-dimensional image and produce a plurality of diffraction light beams of different diffraction orders individually for said apertures based on the two-dimensional image;
(C) a first lens having a front side focal plane on which said two-dimensional image forming apparatus is disposed;
(D) a second lens having a front side focal plane positioned on a rear side focal plane of said first lens; and
(E) a third lens having a front side focal plane positioned on a rear side focal plane of said second lens.

20. The three-dimensional image display apparatus according to claim 19, further comprising
(F) a spatial filter having U₀×V₀ openings controllable between open and closed states and positioned on the rear side focal plane of said first lens.

21. The three-dimensional image display apparatus according to claim 20, wherein said spatial filter is formed from a liquid crystal display apparatus.

22. The three-dimensional image display apparatus according to claim 20, wherein said spatial filter has U₀×V₀ apertures.

23. The three-dimensional image display apparatus according to claim 20, wherein said apertures of said spatial filter have a size substantially equal to that of the two-dimensional image produced by said two-dimensional image forming apparatus and formed on said spatial filter.

24. The three-dimensional image display apparatus according to claim 19, further comprising
(F) a scattering diffraction limiting member having U₀×V₀ apertures and positioned on the rear side focal plane of said first lens.

25. The three-dimensional image display apparatus according to claim 19, wherein each of said planar light emitting members includes:
(a) a rod integrator configured to emit light from a first end face thereof; and
(b) a light emitting diode disposed adjacent a second end face of said rod integrator.

26. The three-dimensional image display apparatus according to claim 19, wherein each of said planar light emitting members includes:
(a) a rod integrator configured to emit light from a first end face thereof;
(b) a light emitting diode disposed adjacent a second end face of said rod integrator;
(c) a reflection type polarizing member disposed adjacent the first end face of said rod integrator and configured to pass part of light incoming thereto in response to a polarization state of the light while reflecting the remaining part of the light; and
(d) a light reflecting member provided at a portion of the second end face of said rod integrator at which said light reflecting member does not intercept light emitted from said light emitting diode.

27. The three-dimensional image display apparatus according to claim 26, wherein each of said planar light emitting members further includes
(e) a quarter-wave plate disposed between the second end face of said rod integrator and said light reflecting member.

28. The three-dimensional image display apparatus according to claim 26, wherein each of said planar light emitting members further includes
(f) a light diffusing member provided on said reflection type polarizing member.

29. The three-dimensional image display apparatus according to claim 19, wherein
each of said planar light emitting members includes
(a) a P and S polarized light separation conversion element including a first prism, a second prism and a polarizing beam splitter, and
(b) a light emitting diode;
said first and second prisms are disposed in an opposing relationship across a polarized light separation face of said polarizing beam splitter;
said first prism has first and second light reflecting members provided at portions thereof at which said first and second light reflecting members do not intercept light emitted from said light emitting diode;
an S polarized light component of light emitted from said light emitting diode and incoming to said first prism is reflected by said polarizing beam splitter, reflected by said second light reflecting member, reflected by said polarizing beam splitter again and then reflected by said first light reflecting member;
a P polarized light component of the light emitted from said light emitting diode and incoming to said first prism and a P polarized light component of the light reflected by said first light reflecting member pass through said polarizing beam splitter thereby to go out from an outgoing face of said second prism.

30. The three-dimensional image display apparatus according to claim 29, wherein each of said planar light emitting members further includes
(c) a quarter-wave plate disposed between said first prism and said first light reflecting member.

31. The three-dimensional image display apparatus according to claim 25, wherein each of said planar light emitting members includes:
(a) a plate-formed member configured to emit light from a first end face thereof;
(b) a light emitting diode disposed adjacent a second end face of said plate-formed member;
(c) a reflection type polarizing member disposed adjacent the first end face of said plate-formed member and configured to pass part of incoming light therethrough in response to a polarization state of the light while reflecting the remaining part of the incoming light;
(d) a light reflecting member provided at a portion of the second end face of said plate-formed member at which said light reflecting member does not intercept the light emitted from said light emitting diode;
(e) a quarter-wave plate disposed between the second end face of said plate-formed member and said light reflecting member; and
(f) a light diffusing member provided on said reflection type polarizing member.

32. The three-dimensional image display apparatus according to claim 19, further comprising
light detection means for measuring the light intensity of the light beams successively emitted from said planar light emitting members.

33. The three-dimensional image display apparatus according to claim 32, wherein the light emitting state of said planar light emitting members is controlled based on a result of the measurement of the light intensity by said light detection means.

34. The three-dimensional image display apparatus according to claim 32, wherein the operation state of said two-dimensional image forming apparatus is controlled based on a result of the measurement of the light intensity by said light detection means.
